(19) United States
(12) Patent Application Publication
(10) Pub. No.: US 2022/0094580 A1
(43) Pub. Date: Mar. 24, 2022

(54) METHOD FOR RECEIVING A SOQPSK-TG SIGNAL WITH PAM DECOMPOSITION

(71) Applicant: SAFRAN DATA SYSTEMS, Courtaboeuf Cedex (FR)

(72) Inventor: Alexandre SKRZYPCZAK, CAEN (FR)

(73) Assignee: SAFRAN DATA SYSTEMS, Courtaboeuf Cedex (FR)

(21) Appl. No.: 17/423,678

(22) PCT Filed: Jan. 17, 2020
(86) PCT No.: PCT/FR2020/050064

§ 371 Date: Jul. 16, 2021

(30) Foreign Application Priority Data
Jan. 17, 2019 (FR) 1900407

(51) Int. Cl. H04L 27/20; H04L 25/02

(52) U.S. Cl. CPC H04L 27/2003; H04L 25/024

(57) ABSTRACT

The invention relates to a method for receiving a CPM signal with space-time encoding, preferably a SOQPSK-TG signal based on the IRIG-106 recommendation, emitted by two emission antennas A1, A2, wherein the received signal modulates a plurality of bits bᵢ^{(j)} j=0 or 1 and corresponds to the bits emitted on the antennas A1 and A2, respectively, said received signal comprising a temporal offset Δτ, said signal being received on one or a plurality of receiving antennas A3; —obtaining a digital signal y(k), which is sampled, and the offset version γ_{Δτ}(k) thereof on an antenna, taking into account the temporal offset between the two antennas, each comprising the contributions of the signals originating from the two emission antennas, wherein said digital signals can be expressed according to the following decomposition: formula (I).

### GENERAL TECHNICAL FIELD

The invention relates to the field of digital telecommunications on a single carrier, particularly applied to the field of aeronautical remote measurement. And the invention more specifically concerns a method for demodulating a signal of OQPSK (Offset Quadrature Phase Keying) type having a time offset making it possible to supply soft outputs.

### PRIOR ART

The initial context is that of the communication of binary data from two transmitting antennas toward one or more receiving antennas. The two transmitting antennas each send a OQPSK signal or a signal resulting from a modulation of CPM (Continuous Phase Modulation) type that may be written in the form of a OQPSK modulation.

If both antennas transmit the same signal and are separated by a distance greater than the wavelength, the radiation diagram shows many lobes, created by alternating a constructive (in phase) or destructive (in phase opposition) addition of the two signals.

This phenomenon gives rise to a break in the telecommunications link in certain directions and polarizations.

One solution to this problem is to transmit over each antenna a number of signals at the same frequency and at the same rate but which have little interference. The most widespread technique for doing this is space-time coding which consists in creating two modulating binary sequences designed such that the signals transmitted from the two antennas are not in phase opposition at each instant of time. This solution can be implemented by a block code on each of the two transmitting paths.

Moreover, due to the relative motion between the different transmitting and receiving antennas, the received signal is the sum of the signal transmitted from one antenna and the signal transmitted from the other antenna with a certain time delay. This time offset (also known as differential offset) can also destroy the quality of the telecommunications link.

One application scenario is aeronautical remote measurement which uses CPM waveforms.

Conventionally, in aeronautical remote measurement applications, an aircraft is in permanent communication with a receiving station, generally on the ground.

In order to guarantee a constant data link, two or more antennas are installed on board the aircraft and separated to cover a different radiation area. Thus, the phenomena previously described can occur.

Recommendation IRIG-106, which describes the physical layer of the remote measurement systems used to guarantee interoperability between aeronautical remote measurement applications, proposes a solution to combat this problem.

This recommendation thus recommends the use of a particular block code, known as the STC (Space Time Coding) code when two transmitting antennas send data by way of a SOQPSK-TG (Shaped Offset Quadrature Phase Shift Keying—Telemetry Group) modulation. This signal transmission technique is known as STC-SOQPSK.

Demodulation solutions implementing an STC coding applied to SOQPSK-TG modulation have been proposed in the documents:
[A1]: N. T. Nelson, “Space-time coding with offset modulations”, Brigham Young University—Provo, 2007;
[A2]: M. Rice, T. Nelson, J. Palmer, C. Lavin and K. Temple, “Space-Time Coding for Aeronautical Telemetry: Part II-Decoder and System Performance,” in IEEE Transactions on Aerospace and Electronic Systems, vol. 53, no. 4, pp. 1732-1754, August 2017

Before implementing the demodulation technique described in these previous references, the received signal is processed according to the receiving scheme described in FIG. 1.

As can be seen in this figure, the received signal is first filtered by a receiving filter. This filtered signal is then digitized by means of an analog-to-digital converter.

A processing for estimating parameters (with regard to this, see document [A3]: M. Rice, J. Palmer, C. Lavin and T. Nelson, “Space-Time Coding for Aeronautical Telemetry: Part I—Estimators,” in IEEE Transactions on Aerospace and Electronic Systems, vol. 53, no. 4, pp. 1709-1731, August 2017) is then used to synchronize the signal in time and in frequency and estimate delays between the two received signals and the gains of the channels using pilot sequences.

The estimate of the frequency offset is then used to correct the frequency offset present in the received signal to obtain a signal written r₀(n).

The signal, written r₀(n), then enters into the demodulator, the operating principle of which shall be described further on in the text. This demodulator makes it possible to obtain a binary sequence.

The binary sequence thus demodulated feeds a decoder which, as output, provides a sequence of binary information items.

The operating principle of the demodulator of the prior art is described in FIG. 2.

The signal r₀(n) is firstly sampled at the symbol rate then, using the estimation block used to estimate the time offset, this same signal r₀(n) is sampled at the symbol rate offset by the estimated time offset.

The two sequences of samples then feed a demodulator using a Viterbi algorithm based on an XTCQM (Cross-Correlated Trellis-Coded Quadrature Modulation) trellis, for example with 16 states. The form of the XTCQM trellis is illustrated in FIGS. 3 and 4 respectively for the case of a positive time offset and for the case of a negative time offset. These XTCQM trellises have the peculiarity of being variable in size in addition to being dependent on the sign of the time offset.

Next, the Viterbi algorithm searches for the binary sequence the most probably transmitted using the XTCQM trellis. To do so, the Viterbi algorithm compares the received signal to all the signals that can be transmitted according to the STC-SOQPSK modulation method.

In practice, this solution cannot be implemented as it has an unreasonable level of complexity. Thus, instead of comparing the received signal to the set of signals that can be transmitted according to the STC-SOQPSK modulation method, the received signal is compared to an approximated version of the signals transmitted by the STC-SOQPSK modulation method.

This approximation is obtained by means of the XTCQM decomposition that is described in document [A1].

This XTCQM makes it possible to approximate an SOQPSK signal by means of 128 waveforms, the appearance of which depends on the value of a block of 7 consecutive bits.

Thus, upon the transmission of STC-SOQPSK signals and as a function of the value of the time offset, a different number of bits are necessary to be able to the received signal approximate as closely as possible, which thus explains the different trellises as well as the numbers of variable states of the XTCQM trellises.

A structure for implementing such a receiver, here known as STBC-XTCQM (Space-Time Block Coding—Cross-Correlated Trellis-Coded Quadrature Modulation) is described in the document [A1].

This demodulation architecture offers acceptable performance for small time offsets but has drawbacks and the following limitations:
A relatively significant degradation of performance when the time offset between the two signals exceeds half the duration of one symbol.
The estimators and the demodulator only take into account the inter-symbol interference inherent to the STC-SOQPSK modulation method. In the presence of a multi-path channel (with reflections), the other interferences are not taken into account, which gives rise to a degradation of the binary error rate.
The sub-trellises of the algorithm have a considerable number of states, namely 256, and differ according to the direction of the time offset between the two signals (advance or delay) due to the use of the XTCQM representation of the STC-SOQPSK signal.
The soft outputs, i.e. symbols weighted by their LLR (Log-Likelihood Ratio) probability are not available with this demodulation architecture which therefore does not make it possible to exploit the advantages of soft-input error correcting codes such as LDPCs or turbo-codes.

### OVERVIEW OF THE INVENTION

The invention proposes to palliate at least one of these drawbacks.

In this regard, the invention relates in a first aspect to a method for receiving a CPM signal with space-time coding, said signal being an SOQPSK-TG signal based on the IRIG-106 recommendation transmitted from two transmitting antennas A1, A2 the received signal modulating a plurality of bits bᵢ^{(j)} j=0 or 1 and corresponding to the bits transmitted over the antenna A1 and A2 respectively, said received signal having a time offset Δτ taking into account the time offset between the signals transmitted from each antenna A1, A2, said signal being received over one or more receiver antennas A3;
obtaining over one antenna a sampled digital signal y(k) and its offset version y_{Δτ}(k) taking into account the time offset between the two transmitting antennas, each comprising the contributions of the signals output by the two transmitting antennas, said digital signals being able to be expressed according to the following decomposition

$${s}_{p} ( t ) \approx {\sum }_{i} {ρ}_{0 , 2 i}^{p} {w}_{0} ( t - 2 {iT}_{b} ) - {ρ}_{1 , 2 i + 1}^{p} {w}_{1} ( t - 2 {iT}_{b} - {T}_{b} ) + ( {\sum }_{i} {ρ}_{0 , 2 i + 1}^{p} {w}_{0} ( t - 2 {iT}_{b} - {T}_{b} ) - {ρ}_{1 , 2 i}^{p} {w}_{1} ( t - 2 {iT}_{b} ) )$$

where:

T_{b} is the duration of one bit;
p∈{0,1}
ρ_{0,i}⁰, ρ_{1,i}⁰ are pseudo-symbols corresponding to the information bits bᵢ⁽⁰⁾ transmitted over the antenna A1, ρ_{0,i}¹, ρ_{1,i}¹ are pseudo-symbols corresponding to the information bits bᵢ⁽¹⁾ transmitted over the antenna;
w₀(t) and w₁(t) are shaping pulses, respectively a main pulse and a secondary pulse;
   defining a Viterbi algorithm having a trellis with fixed metrics and metrics also a function of at least said main pulse;
   obtaining, by means of said Viterbi algorithm, LLRs on the transmitted information bits.

The invention is advantageously completed by the following features, taken alone or in any of their technical possible combinations:

The digital signals obtained are expressed

$$y ( k ) \approx {\sum }_{m = 0}^{1} {\sum }_{i = - \frac{{N}_{t}^{m} - 1}{2}}^{\frac{{N}_{t}^{m} - 1}{2}} {ρ}_{m , k - i}^{0} {\tilde{f}}_{m}^{0} ( i ) + {\sum }_{m = 0}^{1} {\sum }_{i = - \frac{{N}_{t}^{m} - 1}{2}}^{\frac{{N}_{t}^{m} - 1}{2}} {ρ}_{m , k - i}^{1} {\tilde{f}}_{m}^{1 , Δτ} ( i ) + z ( kT + {Δτ}_{0} )$$

$${y}_{Δτ} ( k ) \approx {\sum }_{m = 0}^{1} {\sum }_{i = - \frac{{N}_{t}^{m} - 1}{2}}^{\frac{{N}_{t}^{m} - 1}{2}} {ρ}_{m , k - i}^{0} {\tilde{f}}_{m}^{0 , Δτ} ( i ) + {\sum }_{m = 0}^{1} {\sum }_{i = - \frac{{N}_{t}^{m} - 1}{2}}^{\frac{{N}_{t}^{m} - 1}{2}} {ρ}_{m , k - i}^{1} {\tilde{f}}_{m}^{1} ( i ) + z ( kT + {Δτ}_{1} )$$

where:
Δτ=Δτ₁−Δτ₀ where Δτ₀ is the delay of the direct path from the antenna A1 and Δτ₁ is the delay of the direct path from the antenna A2, Δτ is the time offset;
Δε is the integer the closest to the division of Δτ by T;
   ρ_{0,i}⁰, ρ_{1,i}⁰ are pseudo-symbols corresponding to the information bits transmitted over the antenna A1, ρ_{0,i}⁰, ρ_{1,i}⁰ are pseudo-symbols corresponding to the information bits transmitted over the antenna A2;
   δ(t) is the Dirac pulse centered on 0;
   Nₜ^{m} is the length of the filters \tilde{f}ₘ⁰, \tilde{f}ₘ^{0,Δτ}, \tilde{f}ₘ¹, \tilde{f}ₘ^{1,Δτ},
   z is additive noise.

The values \tilde{f}ₘ⁰, \tilde{f}ₘ^{0,Δτ}, \tilde{f}ₘ¹, \tilde{f}ₘ^{1,Δτ} are defined as follows

\tilde{f}ₘ^{p}(i)=\tilde{f}ₘ^{p}(t=iT)

\tilde{f}ₘ^{0,Δτ}(i)=\tilde{f}ₘ⁰(t=iT+ΔεT)

\tilde{f}ₘ^{1,Δτ}(i)=\tilde{f}ₘ⁰(t=iT−ΔεT)

with

\tilde{f}ₘ^{p}(t)=∫fₘ^{k}(θ)g(θ−t)dθ

and

$${f}_{m}^{0} ( t ) = {w}_{m} ( t ) * ( {h}_{0} δ ( t ) + {\sum }_{i = 1}^{{N}_{0}} {h}_{2 i} δ ( t - ( {Δτ}_{2 i} - {Δτ}_{0} ) ) ) , m ∈ \{ 0 , 1 \}$$

$${f}_{m}^{1} ( t ) = {w}_{m} ( t ) * ( {h}_{1} δ ( t ) + {\sum }_{i = 1}^{{N}_{1}} {h}_{2 i + 1} δ ( t - ( {Δτ}_{2 i + 1} - {Δτ}_{1} ) ) ) , m ∈ \{ 0 , 1 \}$$

where N₀, N₁ are the number of multiple paths respectively coming from the antenna A1 and the antenna A2.

The method comprises prior to the step of obtaining the signals y(k) and its offset version y_{Δτ}(k) a step of filtering the received signal by means of a Finite Impulse Response (FIR) low-pass filter of Equiripple type digitally constructed such that the normalized cut-off frequency is 0.45.

In the absence of multiple paths, the digital signals obtained are grouped into groups of 4 samples and are expressed

$$y ( 4 k ) = {h}_{0} {\sum }_{i = - 1}^{1} {ρ}_{0 , 4 k - i}^{0} {\tilde{w}}_{0} ( iT ) + {h}_{0} {ρ}_{1 , 4 k}^{0} {\tilde{w}}_{1} ( 0 ) + {h}_{1} {\sum }_{i = - 1}^{1} {ρ}_{0 , 4 k - i}^{1} {\tilde{w}}_{0} ( iT - Δɛ T ) + {h}_{1} {ρ}_{1 , 4 k}^{1} {\tilde{w}}_{1} ( - Δɛ T ) + \tilde{n} ( 4 kT )$$

$${y}_{Δτ} ( 4 k ) = {h}_{0} {\sum }_{i = - 1}^{1} {ρ}_{0 , 4 k - i}^{0} {\tilde{w}}_{0} ( iT + Δɛ T ) + {h}_{0} {ρ}_{1 , 4 k}^{0} {\tilde{w}}_{1} ( Δɛ T ) + {h}_{1} {\sum }_{i = - 1}^{1} {ρ}_{0 , 4 k - i}^{1} {\tilde{w}}_{0} ( iT ) + {h}_{1} {ρ}_{1 , 4 k}^{1} {\tilde{w}}_{1} ( 0 ) + \tilde{n} ( 4 kT + Δɛ T )$$

where \tilde{w}₀ and \tilde{w}₁ are filtered versions of a main pulse w₀ and a secondary pulse w₁.

The metrics of the Viterbi algorithm are defined by

$$λ ( {S}_{n - 1} ( i ) -> {S}_{n} ( j ) ) = {\sum }_{m = - 1}^{2} [ {\vert {B}_{m , n}^{( 0 )} \vert}^{2} + {\vert {B}_{m , n}^{( Δτ )} \vert}^{2} ]$$

$$with$$

$${B}_{m , n}^{( 0 )} = y ( 4 n + m ) - {h}_{0} ( {\sum }_{i = - 1}^{1} {ρ}_{0 , 4 n + m - i}^{0} {\tilde{w}}_{0} ( iT ) + {ρ}_{1 , 4 n + m}^{0} {\tilde{w}}_{1} ( 0 ) ) - {h}_{1} ( {\sum }_{i = - 1}^{1} {ρ}_{0 , 4 n + m - i}^{1} {\tilde{w}}_{0} ( iT - Δɛ T ) + {ρ}_{1 , 4 n + m}^{1} {\tilde{w}}_{1} ( - Δɛ T ) )$$

$${B}_{m , n}^{( Δτ )} = {y}_{Δτ} ( 4 n + m ) - {h}_{0} ( {\sum }_{i = - 1}^{1} {ρ}_{0 , 4 n + m - i}^{0} {\tilde{w}}_{0} ( iT + Δɛ T ) + {ρ}_{1 , 4 n + m}^{0} {\tilde{w}}_{1} ( Δɛ T ) ) - {h}_{1} ( {\sum }_{i = - 1}^{1} {ρ}_{0 , 4 n + m - i}^{1} {\tilde{w}}_{0} ( iT ) + {ρ}_{1 , 4 n + m}^{1} {\tilde{w}}_{1} ( 0 ) )$$

where \tilde{w}₀ and \tilde{w}₁ are filtered versions of a main pulse w₀ and a secondary pulse w₁.

In the presence of multiple paths, the method comprises a step of estimating the propagation channel in such a way as to obtain the estimates of \tilde{f}ₘ⁰, \tilde{f}ₘ^{0,Δτ}, \tilde{f}ₘ^{1,Δτ}, the Viterbi algorithm using the estimated parameters of the channel, the metrics of the Viterbi algorithm being defined by

$$λ ( {S}_{n - 1} ( i ) -> {S}_{n} ( j ) ) = {\sum }_{m = - 1}^{2} [ {\vert {B}_{m , n}^{( 0 )} \vert}^{2} + {\vert {B}_{m , n}^{( Δτ )} \vert}^{2} ]$$

$$with$$

$${B}_{m , n}^{( 0 )} = y ( 4 n + m ) - ( {\sum }_{i = - \frac{( {N}_{t} - 1 )}{2}}^{i = \frac{( {N}_{t} - 1 )}{2}} {ρ}_{0 , 4 n + m - i}^{0} {\hat{f}}_{0 , {n}_{p}}^{0} ( i ) + {\sum }_{i = - \frac{( {N}_{t} - 3 )}{2}}^{i = \frac{( {N}_{t} - 3 )}{2}} {ρ}_{1 , 4 n + m - i}^{0} {\hat{f}}_{1 , {n}_{p}}^{0} ( i ) + {\sum }_{i = - \frac{( {N}_{t} - 1 )}{2}}^{i = \frac{( {N}_{t} - 1 )}{2}} {ρ}_{0 , 4 n + m - i}^{1} {\hat{f}}_{0 , {n}_{p}}^{1 , Δτ} ( i ) + {\sum }_{i = - \frac{( {N}_{t} - 3 )}{2}}^{i = \frac{( {N}_{t} - 3 )}{2}} {ρ}_{1 , 4 n + m - i}^{1} {\hat{f}}_{1 , {n}_{p}}^{1 , Δτ} ( i ) )$$

$${B}_{m , n}^{( Δτ )} = {y}_{Δτ} ( 4 n + m ) - ( {\sum }_{i = - \frac{( {N}_{t} - 1 )}{2}}^{i = \frac{( {N}_{t} - 1 )}{2}} {ρ}_{0 , 4 n + m - i}^{0} {\hat{f}}_{0 , {n}_{p}}^{0 , Δτ} ( i ) + {\sum }_{i = - \frac{( {N}_{t} - 3 )}{2}}^{i = \frac{( {N}_{t} - 3 )}{2}} {ρ}_{1 , 4 n + m - i}^{0} {\hat{f}}_{1 , {n}_{p}}^{0 , Δτ} ( i ) + {\sum }_{i = - \frac{( {N}_{t} - 1 )}{2}}^{i = \frac{( {N}_{t} - 1 )}{2}} {ρ}_{0 , 4 n + m - i}^{1} {\hat{f}}_{0 , {n}_{p}}^{1} ( i ) + {\sum }_{i = - \frac{( {N}_{t} - 3 )}{2}}^{i = \frac{( {N}_{t} - 3 )}{2}} {ρ}_{1 , 4 n + m - i}^{1} {\hat{f}}_{1 , {n}_{p}}^{1} ( i ) )$$

In the presence of multiple paths, the method comprises a step of equalization, the Viterbi algorithm using the equalized signal, the metric for each node of the Viterbi being defined by

$$λ ( n ) = \{ \begin{matrix}{β}_{n} ( 2 {x}_{n} - ( D - C ) {ζβ}_{n + 3} - {C ζβ}_{n + 1} - {D ζβ}_{n - 3} ) - {A}_{χ} {\vert {β}_{n} \vert}^{2} & if n = 4 k \\ {β}_{n} ( 2 {x}_{n} - ( D - C ) {ζβ}_{n + 1} - {C ζβ}_{n - 1} - {D ζβ}_{n + 3} ) - {A}_{χ} {\vert {β}_{n} \vert}^{2} & if n = 4 k + 1 \\ {β}_{n} ( 2 {x}_{n} - ( D - C ) {ζβ}_{n - 1} - {D ζβ}_{n + 1} - {C ζβ}_{n - 3} ) - {A}_{χ} {\vert {β}_{n} \vert}^{2} & if n = 4 k + 2 \\ {β}_{n} ( 2 {x}_{n} - {D ζβ}_{n - 1} - {C ζβ}_{n + 3} ) - {A}_{χ} {\vert {β}_{n} \vert}^{2} & if n = 4 k + 3\end{matrix} \\ with \\ χ = {\vert {h}_{0} \vert}^{2} + {\vert {h}_{1} \vert}^{2} ; \\ ζ = Im ( {h}_{0}^{*} {h}_{1} ) \\ A = \frac{1}{2} ( {\tilde{w}}_{0} ( 0 ) + {\tilde{w}}_{0} ( Δɛ T ) ) \\ C = \frac{1}{2} ( {\tilde{w}}_{0} ( - T ) + {\tilde{w}}_{0} ( - T + Δɛ T ) ) \\ D = \frac{1}{2} ( {\tilde{w}}_{0} ( T ) + {\tilde{w}}_{0} ( T + Δɛ T ) )$$

where \tilde{w}₀ and \tilde{w}₁ are filtered versions of a main pulse w₀ and a secondary pulse w₁.

The pseudo-symbols ρ_{0,i}⁰, ρ_{1,i}⁰ corresponding to the information bits transmitted over the antennas A1, A2, are expressed

$${ρ}_{0 , i}^{p} = \{ \begin{matrix}( 2 {b}_{i}^{( p )} - 1 ) & if i is even \\ j ( 2 {b}_{i}^{( p )} - 1 ) & if i is odd\end{matrix} \\ {ρ}_{1 , i}^{p} = \{ \begin{matrix}- j ( 2 {b}_{i - 2}^{( p )} - 1 ) ( 2 {b}_{i - 1}^{( p )} - 1 ) ( 2 {b}_{i}^{( p )} - 1 ) & if i is even \\ - ( 2 {b}_{i - 2}^{( p )} - 1 ) ( 2 {b}_{i - 2}^{( p )} - 1 ) ( 2 {b}_{i}^{( p )} - 1 ) & if i is odd\end{matrix}$$

The method comprises a step of decoding the LLRs by means of a channel decoder or obtaining the heavy-weight bits of the LLRs.

The invention also relates to a receiving device comprising a processing unit configured to implement a method according to the invention.

The invention also relates to a computer program product comprising code instructions for executing a method according to the invention, when the latter is executed by a processor.

### OVERVIEW OF THE FIGURES

Other features, aims and advantages of the invention will become apparent from the following description, which is purely illustrative and non-limiting, and which must be read with reference to the appended drawings in which, besides the FIGS. 1 to 4 already discussed:

FIG. 5 illustrates a transmission-reception scheme according to the invention;

FIG. 6 illustrates a transmission scheme according to the invention

FIG. 7 illustrates a pulse for the PAM—OQPSK decomposition according to the invention;

FIG. 8 illustrates a pulse for the PAM-FQPSK-JR decomposition according to the invention;

FIG. 9 illustrates a recursive precoder according to the invention;

FIG. 10 illustrates a pulse for the PAM-MSK decomposition according to the invention;

FIG. 11 illustrates a pulse for the PAM-GMSK decomposition with a width BT=0.25 according to the invention;

FIG. 12 illustrates a pulse for the PAM-SOQPSK-MIL decomposition according to the invention;

FIG. 13 illustrates a pulse for the PAM-SOQPSK-TG decomposition according to the invention;

FIG. 14 illustrates a reception scheme according to the invention;

FIG. 15 illustrates a demodulation scheme according to a first embodiment of the invention;

FIG. 16 illustrates a filter reducing the inter-symbol interference used in the first embodiment of the invention;

FIG. 17 illustrates a trellis used in the first and second embodiments of the invention;

FIG. 18 illustrates a demodulation scheme according to a second embodiment;

FIG. 19 illustrates a channel estimator of known type;

FIG. 20 illustrates a channel estimator used in the second embodiment of the invention;

FIG. 21 illustrates the principle of the estimation of the channel;

FIG. 22 illustrates a demodulation scheme according to a third embodiment of the invention;

FIG. 23 illustrates a filter reducing the inter-symbol interference used in the third embodiment of the invention;

FIG. 24 illustrates a trellis used in the third embodiment of the invention.

### DETAILED DESCRIPTION OF THE INVENTION

### 1) Description of the Transmission Method

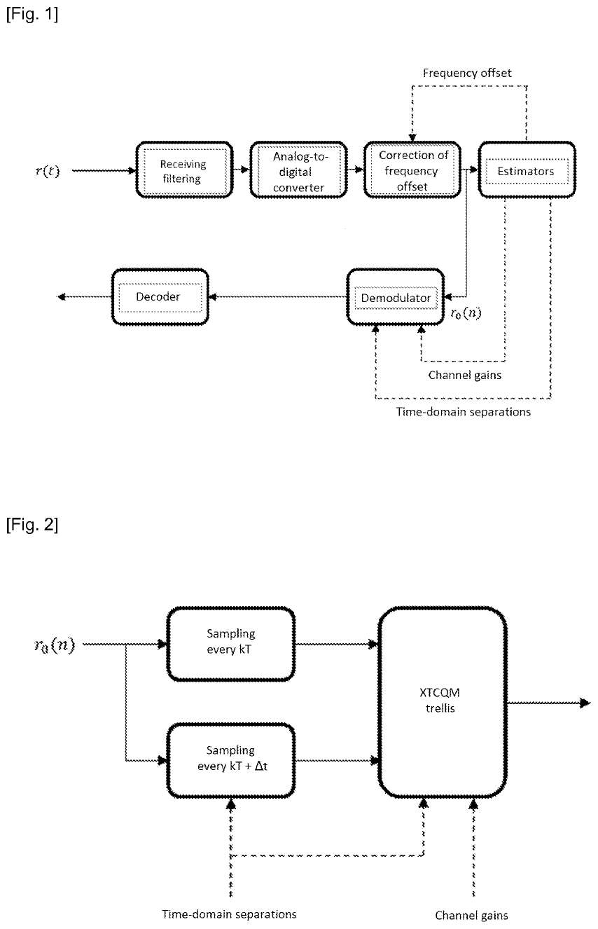

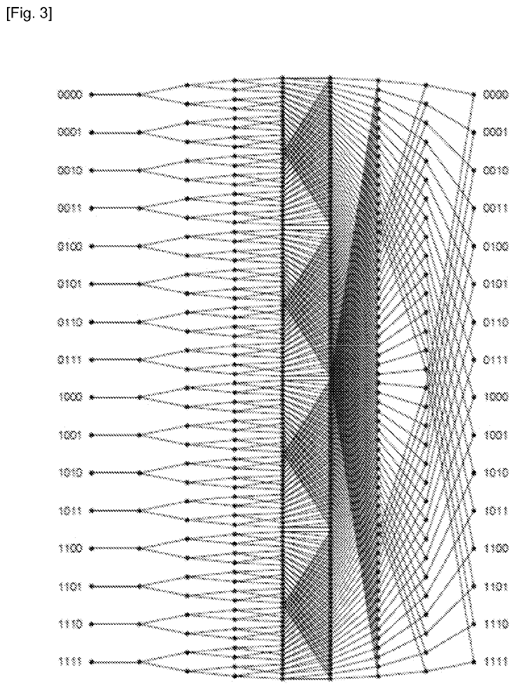

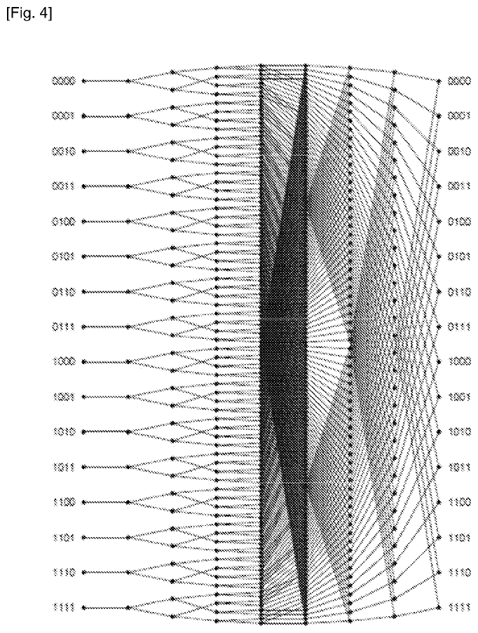

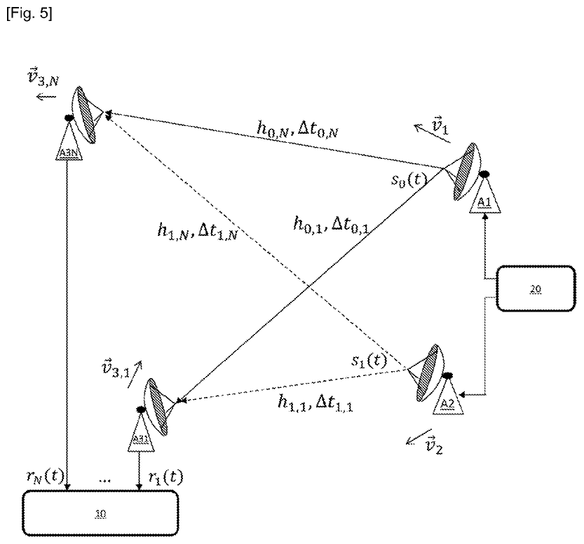

In relation to FIG. 5, two transmitting antennas A1 and A2, which can be mobile at respective speeds \vec{v}₁ and \vec{v}₂ respectively send a signal s₀(t) and s₁(t) to several receiving antennas 3I, I varying from 1 to N, which can, also, be mobile at a speed \vec{v}_{3I}.

The transmitting antennas A1 and A2 are fed by a transmitting device 20 described hereinafter.

The receiving antenna A3 then receives a signal which feeds a receiving device 10 itself described hereinafter.

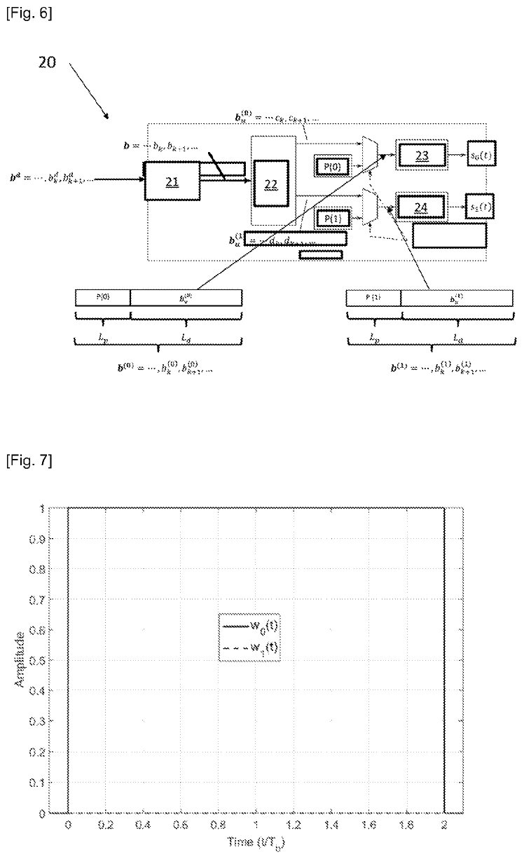

FIG. 6 describes the transmitting device 20 feeding the transmitting antennas.

A series of bits b^{d}=bₖ^{d}, bₖ₊₁^{d}, . . . can advantageously be encoded by an error correcting code (encoder 21 of LDPC or Turbo-Code type for example) in order to make the system robust to noise. A series of bits b= . . . bₖ, bₖ₊₁, . . . is obtained at the output of the encoder 21 or without channel encoding and is then encoded according to a binary rearrangement encoding such that two trains of bits bᵤ⁽⁰⁾= . . . cₖ,cₖ₊₁, . . . and bᵤ⁽¹⁾= . . . dₖ, dₖ₊₁, . . . are obtained at the output of the encoder 22.

This binary rearrangement code is a combination of operations of binary permutation and binary inversion.

On each of the binary trains bᵤ⁽⁰⁾ and bᵤ⁽¹⁾, preamble bits written P(0) and P(1) are added. Thus on the sequence bᵤ⁽⁰⁾ (respectively b)), the preamble P(0) (or P(1) respectively) of size Lₚ is inserted between two data blocks of size L_{d}.

The frames b⁽⁰⁾ and b⁽¹⁾ composed of preamble bits and bits corresponding to the useful data are represented at the bottom of FIG. 6.

These frames thus obtained are modulated by a CPM-type modulation which can be written as a OQPSK modulation by means of two modulators 23, 24, respectively receiving the frames in order to obtain the two signals s₀(t) and s₁(t) which are transmitted on each of the antennas 1, 2.

A signal coming from a modulation of CPM type is written as follows:

$$s ( t ) = \sqrt{\frac{E}{T}} exp ( j 2π {\sum }_{i} {h}_{i} {α}_{i} q ( t - iT ) )$$

with:
αᵢ is an information symbol coming from the alphabet {0, ±2, . . . , ±(M−1)} when M is odd and {±1, ±3, . . . , ±(M−1)} when M is even.
E is the energy of the information symbol
T is the duration of the information symbol
hᵢ is the modulation index
q(t)=∫_{-∞}^{t}g(τ)d_{τ} is defined as the phase pulse and g(t) is the frequency pulse.

The STC-SOQPSK case as described in the IRIG-106 recommendation is a special case of this model where
the transmitting antennas 1 and 2 are mobile;
there is only one receiving antenna (N=1);
the error-correcting code is an LDPC code as described in the IRIG-106 recommendation
the binary rearrangement code constructed on the basis of the sequence b= . . . b₄ₖ, b₄ₖ₊₁, b₄ₖ₊₂, b₄ₖ₊₃, . . . the sequences bᵤ⁽⁰⁾= . . . b₄ₖ, b₄ₖ₊₁, b̅₄ₖ₊₂, b₄ₖ₊₃, . . . and bᵤ⁽¹⁾= . . . b₄ₖ₊₂ b₄ₖ₊₃, b₄ₖ, b̅₄ₖ₊₁, . . . where the operation x represents the binary inversion operation of the bit x
the preambles P(0) and P(1) are as described in the IRIG-106 recommendation with Lₚ=128 and L_{d}=3200
M=3
The symbols αᵢ are as described in the IRIG-106 recommendation.
hᵢ=½
q(t) and g(t) are as described in the IRIG-106 recommendation

### 2) CPM Signals that can be Written in the Form of OQPSK Modulation

A signal resulting from a CPM-type modulation that can be written as an OQPSK modulation makes it possible to write accurately or approximately the signal s(t) previously defined as:

$${s}_{p} ( t ) \approx {\sum }_{i} {ρ}_{0 , 2 i}^{p} {w}_{0} ( t - 2 {iT}_{b} ) - {ρ}_{1 , 2 i + 1}^{p} {w}_{1} ( t - 2 {iT}_{b} - {T}_{b} ) + ( {\sum }_{i} {ρ}_{0 , 2 i + 1}^{p} {w}_{0} ( t - 2 {iT}_{b} - {T}_{b} ) - {ρ}_{1 , 2 i}^{p} {w}_{1} ( t - 2 {iT}_{b} ) )$$

where:
p∈{0,1}
ρᵢ⁰ and ρᵢ¹ are pseudo-symbols analytically expressed as follows:

$${ρ}_{0 , i}^{p} = \{ \begin{matrix}( 2 {b}_{i}^{( p )} - 1 ) & if i is even \\ j ( 2 {b}_{i}^{( p )} - 1 ) & if i is odd\end{matrix} \\ {ρ}_{1 , i}^{p} = \{ \begin{matrix}- j ( 2 {b}_{i - 2}^{( p )} - 1 ) ( 2 {b}_{i - 1}^{( p )} - 1 ) ( 2 {b}_{i}^{( p )} - 1 ) & if i is even \\ - ( 2 {b}_{i - 2}^{( p )} - 1 ) ( 2 {b}_{i - 2}^{( p )} - 1 ) ( 2 {b}_{i}^{( p )} - 1 ) & if i is odd\end{matrix}$$

bᵢ⁽⁰⁾ and bᵢ⁽¹⁾ are respectively the information bits feeding the SOQPSK modulator of path 1 and path 2.
w₀(t) and w₁(t) are shaping pulses.

The obtainment of this analytical expression is described in detail in the document [A4].
[A4]: R. Othman, A. Skrzypczak, Y. Louët, “PAM Decomposition of Ternary CPM with Duobinary Encoding”, IEEE Transactions on Communications, vol. 65, no. 10, pp. 4274-4284, October 2017;

The decomposition above can be applied to certain modulations such as OQPSK modulation. In this scenario, the pulses w₀ and w₁ are shown in FIG. 7.

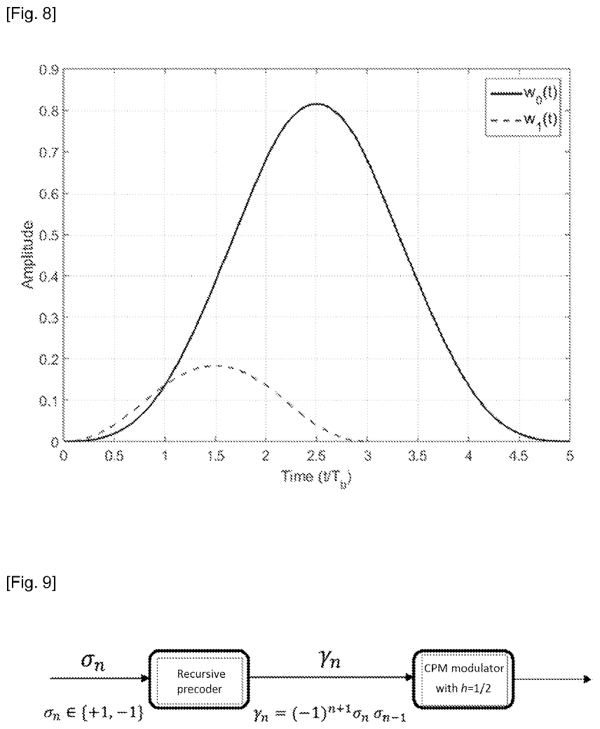

Similarly, FQPSK-JR modulation (Feher's patented Quadrature Phase Shift Keying), described in the IRIG 106, can also be expressed in this form with the pulses w₀ and w₁ shown in FIG. 8.

Finally, any CPM modulation of index h=½ containing a recursive precoder of the form described in FIG. 9 can be written in this form.

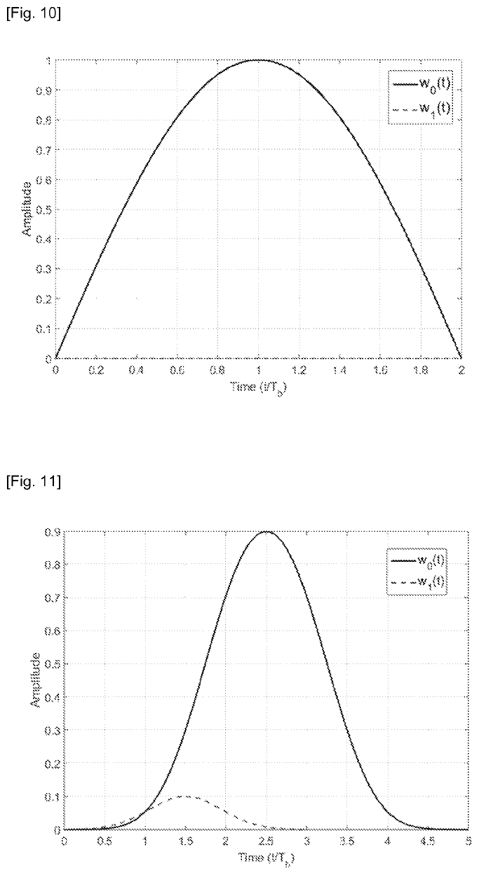

In particular, MSK (Minimum Shift Keying) modulation falls within this category. The associated pulses w₀ and w₁ are shown in FIG. 10.

In particular, GMSK (Gaussian Minimum Shift Keying) modulation can also be written in this form. For the special case of GMSK with BT=0.25, the associated pulses w₀ and w₁ are shown in FIG. 11.

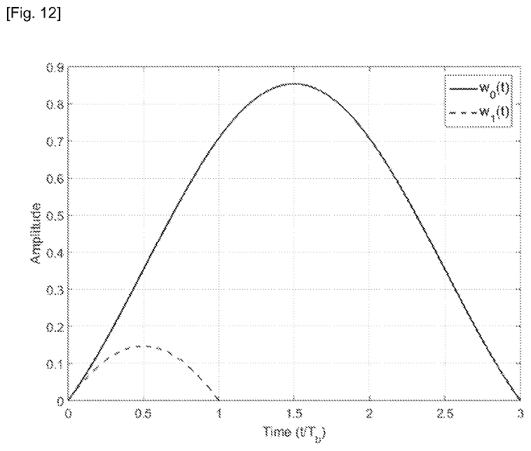

In particular, SOQPSK-MIL modulation as described in the IRIG 106 also falls within this category. The associated pulses w₀ and w₁ are shown in FIG. 12.

Finally, SOQPSK-TG modulation as described in the IRIG 106 also falls within this category. The associated pulses w₀ and w₁ are shown in FIG. 13.

### 3) Description of the Receiving Method

There now follows a model of the expression of the signal at the input of the receiving device E2 of FIG. 1. This signal received over the antenna I, written r_{I}(t), with I varying from 1 to N, is analytically expressed:

r_{I}(t)=[h_{0,I}s₀(t−Δt_{0,I})+h_{1,I}s₁(t−Δt_{1,I})]e^{j2πΔf}^{_{I}}^{t}+z_{I}(t)

with
h_{0,I} the complex gain associated with the direct-line propagation of the signal s₀(t) from the transmitting antenna 1 to the receiving antenna I.
h_{1,I} the complex gain associated with the direct-line propagation of the signal s₁(t) from the transmitting antenna 2 to the receiving antenna I.
Δt_{0,I} is the delay due to the propagation of the signal s₀(t) between the transmitting antenna 1 and the receiving antenna I;
Δτ_{1,I} is the delay due to the propagation of the signal s₁(t) between the transmitting antenna 2 and the receiving antenna I;
Δf_{I} the frequency offset seen from the receiving antenna I;
z_{I}(t) an additive noise on the antenna I.

The time offset seen on the antenna I will be written in the remainder of the text as Δτ_{I}=Δt_{1,I}−Δt_{0,I}.

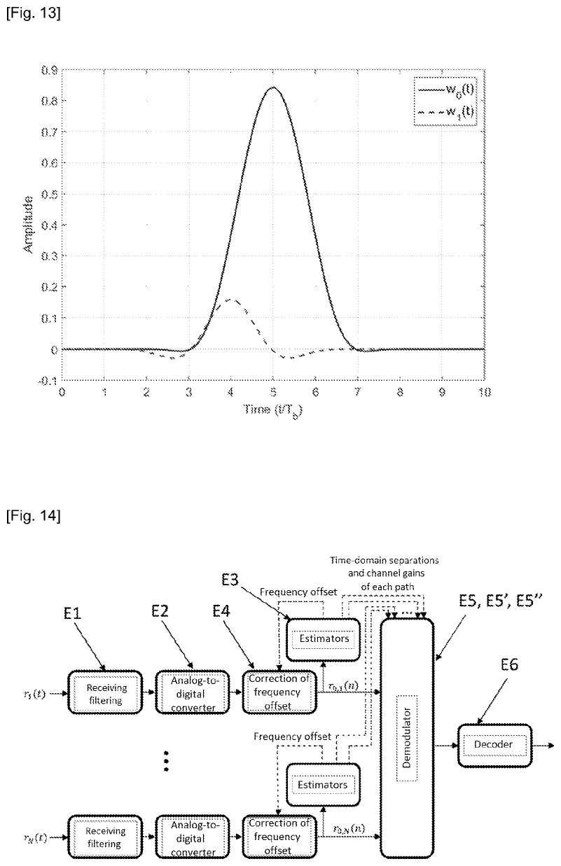

The reception device of this signal is described in FIG. 14.

On each reception channel I corresponding to the processing path of the signal received over the antenna I, I varying from 1 to N, the signal is first filtered (step E1) by a receiving filter. This filtered signal is then digitized (step E2).

A synchronization method (step E3) identical to that described in the document [A3] is used in order to synchronize the signal in time and in frequency (by estimating Δf_{I}) and in order to estimate the delays Δt_{0,I} and Δt_{1,I} as well as the channel gains h_{0,I} and h_{1,I}.

The frequency offset is corrected (step E4) using the estimate of the frequency offset previously produced.

This gives N sequences of samples r_{0,1}(n), . . . , r_{0,N}(n) feeding the demodulator. In the same way, the different estimates of the delays Δt_{0,I} and Δt_{1,I} and of the channel gains h_{0,I} and h_{1,I} are involved as parameters of the demodulator.

At the demodulator output, an LLR sequence is obtained. This LLR sequence then feeds a decoder.

The present invention described here consists in the demodulation (step E5, E5′, E5″) of the signal by the demodulator using the advantageous expression of the signal STC-SOQPSK based on the IRIG-106 recommendation modeled as described above. Such an expression makes it possible to simplify the processing of the demodulator.

According to a first embodiment (see part 4) hereinafter), the demodulation (step E5) dispenses with multiple paths (and only takes into account the two main paths) such that the N sequences of samples r_{0,1}(n), . . . , r_{0,N}(n) feeding the demodulator have expressions that simplify. As will be seen in more detail, each sequence of samples is first filtered by a matched filter (step E51) then the signal is sampled (step E52) using the parameters Δt_{0,I} and Δt_{1,I} estimated at the times kT and also at the times kT+Δt_{I}. This respectively gives the sequences of samples y_{I}(k),y_{Δτ}_{_{I}}(k) and y_{Δτ}_{_{I}}(k) being the offset version of the time offset of the signal y_{I}(k). These signals thus sampled then feed a Viterbi algorithm (Trellis 1) (step E53) having branch metrics specific to the expressions of the signals. This gives at the output of Trellis 1 a sequence of soft-output demodulated bits of LLR (Log Likelihood Ratio) type. This sequence of demodulated bits is then decoded (step E6).

According to a second embodiment (see part 5) hereinafter), the demodulation (step E5′) considers the multiple paths in addition to the direct paths. The expressions of the N sequences of samples r_{0,1}(n), . . . , r_{0,N}(n) feeding the demodulator are certainly more complex than those of the first embodiment, but the demodulator performs better. As for the first embodiment, each sequence of samples is firstly filtered by a matched filter (step E51′) then the signal is sampled (step E52′) using the parameters Δt_{0,I} and Δt_{1,I} estimated at the times kT and also at the times kT+Δt_{I}. This respectively gives the sequences of samples y_{I}(k) and y_{Δτ}_{_{I}}(k). This second embodiment differs from the first in that it comprises a step of estimating the parameters of the propagation channels (step E54′) which are used by the Viterbi algorithm which uses the parameters of the channels to estimate the gains h_{0,1}, h_{1,1}, . . . , h_{0,N}, h_{1,N} and equalize the signals at the same time as the demodulation. Thus, the sampled signals and the parameters of the propagation channels feed a Viterbi algorithm (Trellis 1) (step E53′) having branch metrics specific to the expressions of the signals. This gives at the output of Trellis 1 a sequence of soft-output demodulated bits of LLR type. This sequence of demodulated bits is then decoded (step E6).

According to a third embodiment (see part 6)), the demodulation (step E5″) considers, as for the second embodiment, the multiple paths in addition to the direct paths. The different between this third embodiment and the second embodiment is that the signals are equalized before being input into the Viterbi algorithm (Trellis 2). Here again, each sequence of samples is first filtered by a matched filter (step E51″) then the signal is sampled (step E52″) using the parameters Δt_{0,I} and Δt_{1,I} estimated at the times kT and also at the times kT+Δt_{I}. This respectively gives the sequences of samples y_{I}(k) and y_{Δτ}_{_{I}}(k). These sampled signals are then equalized (step E54″) by means of estimates of the channel gains h_{0,I} and h_{1,I}, and the equalized signals then feed a Viterbi algorithm (Trellis 2) (step E53″). This gives at the output of Trellis 2 a sequence of soft-output demodulated bits of LLR (Log Likelihood Ratio) type. This sequence of demodulated bits is then decoded (step E6).

There follows a description of the different embodiments presented.

### 4) First Embodiment, without Multiple Paths

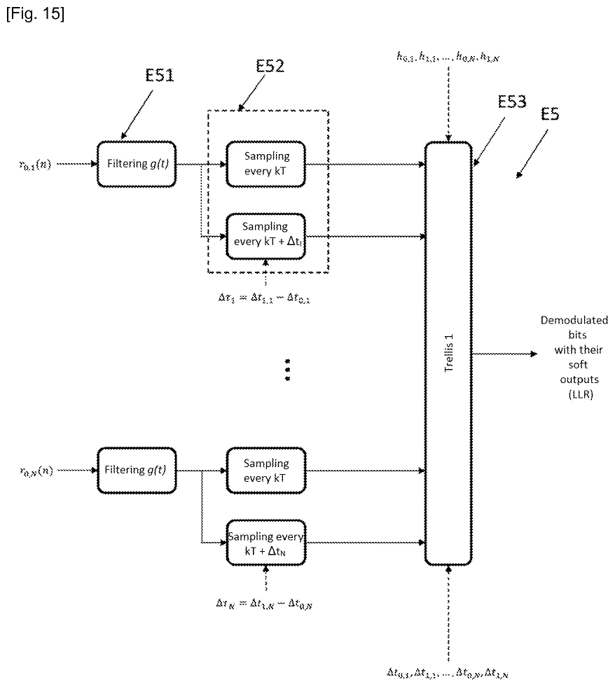

This demodulation architecture is described in FIG. 15. This architecture has N inputs corresponding to the N sequences of samples r_{0,1}(n), . . . , r_{0,N}(n) feeding the demodulator. This architecture also requires the estimates of the delays Δt_{0,1}, Δt_{1,1}, . . . , Δt_{0,N}, Δt_{1,N} along with the estimates of the channel gains h_{0,1}, h_{1,1}, . . . , h_{0,N}, h_{1,N}. At the output of this demodulation architecture, a sequence of soft-output demodulated bits (LLR) is obtained.

The sequence of samples r_{0,I}(n) with I varying from 1 to N is first filtered by a filter making it possible to optimize the signal-to-noise ratio at the demodulation input. This filter can be simply a matched filter.

Using the parameters Δt_{0,I} and Δt_{1,I}, the signal is sampled firstly at the times kT and secondly at the times kT+Δt_{I}. This then respectively gives the sequences of samples y_{I}(k) and y_{Δτ}_{_{I}}(k).

The two sequences y₁(k), y_{Δτ}_{₁}(k), . . . , y_{N} (k),y_{Δτ}_{_{N}}(k) then feed a trellis 1. This method also requires the knowledge of certain parameters Δt_{0,1},Δt_{1,1}, . . . , Δt_{0,N}, Δt_{1,N} as well as the parameters h_{0,1}, h_{1,1}, . . . , h_{0,N}, h_{1,N}.

By writing L the number of bits involved in the space-time coding, the trellis used then has 2^{L} states and 2^{2L} branches.

This trellis can then be used to estimate the most likely transmitted binary sequence. Moreover, a single trellis having a fixed number of states can be used to compute LLRs. This is referred to as a fixed trellis.

The computation of the LLRs on the information bits can then be done by way of a SOVA (Soft Output Viterbi Algorithm). The description of this algorithm is given in the document [A5].
[A5]: J. Hagenauer and P. Hoeher, “A Viterbi Algorithm with Soft-Decision Outputs and its Application”, Global Telecommunications Conference and Exhibition (IEEE GLOBECOM), pp. 1680-1686, vol. 3, November 1989.

The advantages of this architecture are several.

1. The presence of the filter for reducing the inter-symbol interference present at the input of the demodulator makes it possible to greatly reduce the complexity of the equalization blocks and to simplify the trellis used for the Viterbi algorithm.

2. The particular decomposition of the CPM signal in the form of a modulation of OQPSK type has the consequence of enabling the use a fixed trellis.

3. The single and fixed trellis used in the Viterbi algorithm has the advantage of using an algorithm of SOVA type in order to compute the LLRs on the demodulated bits.

4. The whole demodulation method is more robust at high values of the time offset Δt_{1,I}−Δt_{0,N} by comparison with the solution of the prior art.

5. The trellis has the advantage of requiring fewer computational resources by comparison with the solution of the prior art.

6. Even without a channel decoder for decoding the LLRs, the use of a hard decision (Most Significant Bit, (MSB)) on the LLRs leads to an improvement of the performance.

This demodulation architecture makes use of the fact that the received signal can be written via a very precise approximation of the signals.

In the special case of STC-SOQPSK based on the IRIG-106 recommendation, supposing that the frequency offset has been perfectly corrected, the received signal can be written as follows:

$${r}_{0} ( n ) \approx {h}_{0} \underbrace{[ {\sum }_{i} {ρ}_{0 , i}^{0} {w}_{0} ( {nT}^{′} - iT ) + {\sum }_{i} {ρ}_{1 , i}^{0} {w}_{1} ( {nT}^{′} - iT ) ]}_{{s}_{0} ( {nT}^{′} )} + {h}_{1} \underbrace{[ {\sum }_{i} {ρ}_{0 , i}^{1} {w}_{0} ( {nT}^{′} - iT - Δτ ) + {\sum }_{i} {ρ}_{1 , i}^{1} {w}_{1} ( {nT}^{′} - iT - Δτ ) ]}_{{s}_{0} ( {nT}^{′} - Δτ )} + z ( {nT}^{′} )$$

where:
T′ is the sampling duration of the analog-to-digital converter (consequently T′<<T)
w₀ is the main pulse of the decomposition of the CPM signal in the form of OQPSK modulation, shown in FIG. 13
w₁ is the secondary pulse of the decomposition of the CPM signal in the form of OQPSK modulation, shown in FIG. 13
h₀, h₁ and Δτ are respectively the channel gain resulting from the propagation between the transmitting antenna 1 and the receiving antenna, the channel gain resulting from the propagation between the transmitting antenna 2 and the receiving antenna and the time offset defined as Δτ=Δt₁−Δt₀.
z is additive noise
ρ_{0,i}⁰, ρ_{0,i}¹, ρ_{1,i}⁰ and ρ_{1,i}¹ are pseudo-symbols analytically expressed as, respectively:

$${ρ}_{0 , i}^{p} = \{ \begin{matrix}( 2 {b}_{i}^{( p )} - 1 ) & if i is even \\ j ( 2 {b}_{i}^{( p )} - 1 ) & if i is odd\end{matrix} \\ {ρ}_{1 , i}^{p} = \{ \begin{matrix}- j ( 2 {b}_{i - 2}^{( p )} - 1 ) ( 2 {b}_{i - 1}^{( p )} - 1 ) ( 2 {b}_{i}^{( p )} - 1 ) & if i is even \\ - ( 2 {b}_{i - 2}^{( p )} - 1 ) ( 2 {b}_{i - 2}^{( p )} - 1 ) ( 2 {b}_{i}^{( p )} - 1 ) & if i is odd\end{matrix}$$

bᵢ⁽⁰⁾ and bᵢ⁽¹⁾ are respectively the information bits feeding the SOQPSK modulator of the path 1 and the path 2 (see FIG. 6).

It is recalled that bᵢ⁽⁰⁾ and bᵢ⁽¹⁾ are connected to one another by way of the binary rearrangement code defined in the IRIG-106 recommendation. The binary rearrangement code constructs on the basis of the sequence b= . . . b₄ₖ, b₄ₖ₊₁, b₄ₖ₊₂, b₄ₖ₊₃, . . . the sequences:

bᵤ⁽⁰⁾= . . . b₄ₖ⁽⁰⁾,b₄ₖ₊₁⁽⁰⁾,b₄ₖ₊₂⁽⁰⁾,b_{4k+3′}⁽⁰⁾, . . . = . . . b₄ₖ,b_{4k+1,}b̅_{4k+2,}b₄ₖ₊₃, . . .

bᵤ⁽¹⁾= . . . b₄ₖ⁽¹⁾,b₄ₖ₊₁⁽¹⁾,b₄ₖ₊₂⁽¹⁾,b_{4k+3′}⁽¹⁾, . . . = . . . b₄ₖ₊₂,b_{4k+3,}b_{4k,}b̅₄ₖ₊₁, . . .

where the operation x̅ represents the binary inversion operation of the bit x. This consequently gives L=4.

The samples r₀(n) are then filtered by a filter making it possible to reduce the inter-symbol interference. Specifically, as w₀ and w₁ are pulses having a time base larger than T, inter-symbol interference is present in the received signal.

This filter must have the following features:
It must not color the noise component present in the received signal
It must have a bandwidth wider than that of the useful signal.
It must reduce the inter-symbol interference.

A matched filter can be sufficient. However, it has the drawback of coloring the noise.

Different filters satisfying the above conditions are possible. The reference [A6] has several filters that can be used in this scenario.
[A6] Geoghegan, Mark, “Optimal Linear Detection of SOQPSK,” in International Telemetering Conference Proceedings, October 2002

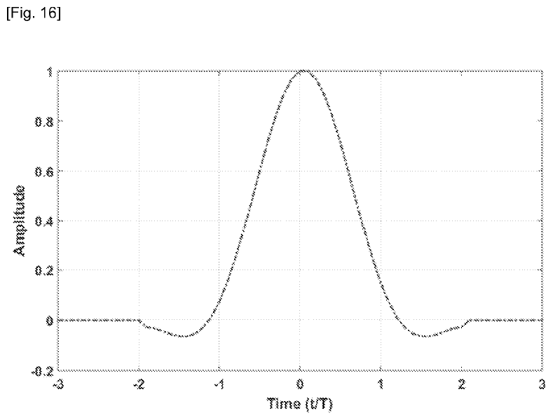

The filter g shown in FIG. 16 has been determined such as to satisfy the conditions above.

The filter chosen is a FIR (Finite Impulse Response) low-pass filter of Equiripple type digitally constructed such that the normalized cut-off frequency is 0.45.

Thus, at the output of this filter and after the operations of sampling at the symbol rate, we have:

$$y ( 4 k ) = {h}_{0} {\sum }_{i = - 1}^{1} {ρ}_{0 , 4 k - i}^{0} {\tilde{w}}_{0} ( iT ) + {h}_{1} {\sum }_{i = - 1}^{1} {ρ}_{0 , 4 k - i}^{1} {\tilde{w}}_{0} ( iT - Δɛ T ) + \tilde{n} ( 4 kT )$$

$${y}_{Δτ} ( 4 k ) = {h}_{0} {\sum }_{i = - 1}^{1} {ρ}_{0 , 4 k - i}^{0} {\tilde{w}}_{0} ( iT + Δɛ T ) + {h}_{1} {\sum }_{i = - 1}^{1} {ρ}_{0 , 4 k - i}^{1} {\tilde{w}}_{0} ( iT ) + \tilde{n} ( 4 kT + Δɛ T )$$

where \tilde{w}₀ is the result of the convolution product between the pulse w₀ and the filter g, ñ is the result of the convolution product between the noise z and the filter g and Δε is the closest integer of the division of Δτ by T.

Thus, at the output of this filter and after the sampling operations, we have:

$$y ( 4 k ) = {h}_{0} {\sum }_{i = - 1}^{1} {ρ}_{0 , 4 k - i}^{0} {\tilde{w}}_{0} ( iT ) + {h}_{0} {ρ}_{1 , 4 k}^{0} {\tilde{w}}_{1} ( 0 ) + {h}_{1} {\sum }_{i = - 1}^{1} {ρ}_{0 , 4 k - i}^{1} {\tilde{w}}_{0} ( iT - Δɛ T ) + {h}_{1} {ρ}_{1 , 4 k}^{1} {\tilde{w}}_{1} ( - Δɛ T ) + \tilde{n} ( 4 kT )$$

$${y}_{Δτ} ( 4 k ) = {h}_{0} {\sum }_{i = - 1}^{1} {ρ}_{0 , 4 k - i}^{0} {\tilde{w}}_{0} ( iT + Δɛ T ) + {h}_{0} {ρ}_{1 , 4 k}^{0} {\tilde{w}}_{1} ( Δɛ T ) + {h}_{1} {\sum }_{i = - 1}^{1} {ρ}_{0 , 4 k - i}^{1} {\tilde{w}}_{0} ( iT ) + {h}_{1} {ρ}_{1 , 4 k}^{1} {\tilde{w}}_{1} ( 0 ) + \tilde{n} ( 4 kT + Δɛ T )$$

These two sample sequences then feed a trellis which has the aim of finding a binary sequence making it possible to maximize or minimize a given cost function.

In this scenario, this trellis seeks to minimize the mean quadratic error between the received signal and the signal reconstructed by approximation.

In other words, a Viterbi algorithm is used seeking to find the best sequence of bits Ŝ making it possible to solve the following problem:

$$\underline{\hat{S}} = {argmin}_{S} Λ ( \underline{S} )$$

$$with : \\ Λ ( \underline{S} ) = {\sum }_{n = 0}^{( N - 1 ) / 4} ( {\sum }_{m = - 1}^{2} [ {\vert {B}_{m , n}^{( 0 )} \vert}^{2} + {\vert {B}_{m , n}^{( Δ τ )} \vert}^{2} ] )$$

$$Writing : \\ {B}_{m , n}^{0} = y ( 4 n + m ) - {h}_{0} ( {\sum }_{i = - 1}^{1} {ρ}_{0 , 4 n + m - i}^{0} {\tilde{w}}_{0} ( iT ) + {ρ}_{1 , 4 n + m}^{0} {\tilde{w}}_{1} ( 0 ) ) - {h}_{1} ( {\sum }_{i = - 1}^{1} {ρ}_{0 , 4 n + m - i}^{1} {\tilde{w}}_{0} ( iT - Δɛ T ) + {ρ}_{1 , 4 n + m}^{1} {\tilde{w}}_{1} ( - Δɛ T ) )$$

$${B}_{m , n}^{( Δτ )} = {y}_{Δτ} ( 4 n + m ) - {h}_{0} ( {\sum }_{i = - 1}^{1} {ρ}_{0 , 4 n + m - i}^{0} {\tilde{w}}_{0} ( iT + Δɛ T ) + {ρ}_{1 , 4 n + m}^{0} {\tilde{w}}_{1} ( Δɛ T ) ) - {h}_{1} ( {\sum }_{i = - 1}^{1} {ρ}_{0 , 4 n + m - i}^{1} {\tilde{w}}_{0} ( iT ) + {ρ}_{1 , 4 n + m}^{1} {\tilde{w}}_{1} ( 0 ) )$$

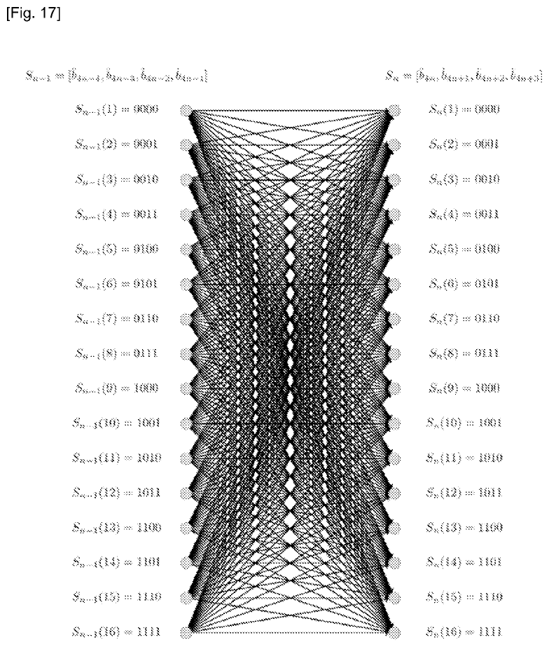

The information bits are therefore retrieved using a Viterbi algorithm associated with the trellis illustrated in FIG. 17.

The trellis under consideration describes the transitions from a state Sₙ=[b₄ₙ b₄ₙ₊₁ b₄ₙ₊₂ b₄ₙ₊₃] to a state Sₙ₊₁=[b₄ₙ₊₄ b₄ₙ₊₅ b₄ₙ₊₆ b₄ₙ₊₇]. The transitions are weighted via the following branch metric:

$$λ ( {S}_{n - 1} ( i ) -> {S}_{n} ( j ) ) = {\sum }_{m = - 1}^{2} [ {\vert {B}_{m , n}^{( 0 )} \vert}^{2} + {\vert {B}_{m , n}^{( Δ r )} \vert}^{2} ]$$

The trellis therefore includes 16 states, describing the 16 possible states of the variable Sₙ. The number of branches to be computed is then 256.

The use of the trellis associated with this architecture therefore makes it possible, using the branch metrics defined above, to use an algorithm of SOVA type in order to compute the LLRs on the information bits.

Soft outputs in the form of LLRs and/or hard outputs are thus obtained by performing the following operations.

First the cumulative metrics Γₙ(Sₙ(j)) of the nodes Sₙ(j) are computed at the epoch n:

Γₙ(Sₙ(j))=minᵢ[γₙ(Sₙ₋₁(i),Sₙ(j))],(i,j)∈{1, . . . ,16}²

with

γₙ(Sₙ₋₁(i),Sₙ(j))=Γₙ₋₁(Sₙ₋₁(i))+λ(Sₙ₋₁(i)→Sₙ(j))

The likelihood difference is computed:

Rₙ(Sₙ₋₁(i),Sₙ(j))=Γₙ(Sₙ(j))−γₙ(Sₙ₋₁(i),Sₙ(j)),(i,j)∈({1, . . . ,16})²

The maximum of the joint probability logarithm is then computed:

P(Sₙ₋₁(i),Sₙ(j),r^{f})=βₙ(Sₙ(i))+Rₙ(Sₙ₋₁(i),Sₙ(j))

with

βₙ₋₁(Sₙ₋₁(j))=minᵢ[Rₙ(Sₙ₋₁(i),Sₙ(j))+βₙ(Sₙ(i))]

The soft outputs (or LLRs) of the symbol Ŝₙ, estimated from the symbol Sₙ, are:

LLR(Ŝₙ)=P(Ŝₙ=Sₙ(j)\r^{f})

with

P(Ŝₙ=Sₙ(j)\r^{f})=minᵢ[P(Sₙ₋₁(i),Sₙ(j),r^{f}]

The conversion of the symbol LLRs Ŝₙ to the bit LLRs (\hat{b}₄ₙ, \hat{b}₄ₙ₊₁, \hat{b}₄ₙ₊₂, \hat{b}₄ₙ₊₃) is done as follows:

LLR(\hat{b}₄ₙ)=min(LLR(Ŝₙ=[0,\tilde{b}₄ₙ₊₁,\tilde{b}₄ₙ₊₂,\tilde{b}₄ₙ₊₃]))−min(LLR(Ŝₙ=[1,\tilde{b}₄ₙ₊₁,\tilde{b}₄ₙ₊₂,\tilde{b}₄ₙ₊₃]))

LLR(\hat{b}₄ₙ₊₁)=min(LLR(Ŝₙ=[\tilde{b}₄ₙ,0,\tilde{b}₄ₙ₊₂,\tilde{b}₄ₙ₊₃]))−min(LLR(Ŝₙ=[\tilde{b}₄ₙ,1,\tilde{b}₄ₙ₊₂,\tilde{b}₄ₙ₊₃]))

LLR(\hat{b}₄ₙ₊₂)=min(LLR(Ŝₙ=[\tilde{b}₄ₙ,\tilde{b}₄ₙ₊₁,0,\tilde{b}₄ₙ₊₃]))−min(LLR(Ŝₙ=[\tilde{b}₄ₙ,\tilde{b}₄ₙ₊₁,1,\tilde{b}₄ₙ₊₃]))

LLR(\hat{b}₄ₙ₊₃)=min(LLR(Ŝₙ=[\tilde{b}₄ₙ,\tilde{b}₄ₙ₊₁,\tilde{b}₄ₙ₊₃,0]))−min(LLR(Ŝₙ=[\tilde{b}₄ₙ,\tilde{b}₄ₙ₊₁,\tilde{b}₄ₙ₊₂,1]))

The hard outputs are thus obtained by:

\hat{b}₄ₙ=sign(LLR(\hat{b}₄ₙ))

\hat{b}₄ₙ₊₁=sign(LLR(\hat{b}₄ₙ₊₁))

\hat{b}₄ₙ₊₂=sign(LLR(\hat{b}₄ₙ₊₂))

\hat{b}₄ₙ₊₃=sign(LLR(\hat{b}₄ₙ₊₃))

With sign(x) a function that returns 1 if 1, if x≥0, −1 if x<0. The estimated binary sequence of data is therefore

\hat{b}ₙ^{d}=½(\hat{b}ₙ+1)

The bit LLRs are then supplied to the error correcting decoder (of LDPC type for example) in order to further correct the errors generated by the presence of noise. The decoder can operate with the two outputs (hard or soft outputs). However, it is more advantageous to use the bit LLRs since these information items are made more use of by the decoder to improve the overall performance of the system.

### 5) Second Embodiment: Taking into Account of the Multiple Paths and Channel Estimation as a Replacement for the Channel Gain Estimates of the First Embodiment

The architecture proposed here makes it possible to solve a more general problem. Specifically, this concerns the case where the signal received over the antenna I written r_{I}(t) is composed of two main paths and a number of multiple paths. The multiple paths are the result of reflections of the transmitted signal either on the ground or in the atmosphere.

The received signal r(t) is expressed in this case as follows:

$${r}_{I} ( t ) = [ {\sum }_{i = 0}^{{N}_{0 , I}} {h}_{2 i , I} {s}_{0} ( t - {Δτ}_{2 i , I} ) + {\sum }_{j = 0}^{{N}_{1 , I}} {h}_{2 j + 1} {s}_{1} ( t - {Δτ}_{2 j + 1 , I} ) ] {e}^{{( j 2 πΔ f )}_{I} t} + {z}_{I} ( t )$$

with
N_{0,I}, N_{1,I} the number of paths associated respectively with the signals s₀(t),s₁(t) considering the receiving antenna I.
{h_{2i,I}}_{i∈{0,N}_{₀}_{}} the gains associated with the propagation channels of the direct-line path associated with the signal s₀(t) over the receiving antenna I. The gain of the channel associated with the main path is h_{0,I}
{h_{2j+1,I}}_{j∈{0,N}_{₁}_{}} the gains associated with the propagation channels of the direct-line path associated with the signal s₁(t) over the receiving antenna I. The gain of the channel associated with the main path is h_{1,I}
{Δτ_{2i,I}}_{j∈{0,N}_{₀}_{}}, {Δτ_{2j+1,I}}_{j∈{0,N}_{₁}_{}} the delays associated with these paths on the receiving antenna I;
Δf_{I} the frequency offset;
z_{I}(t) additive noise.

It is moreover recalled that:

$${s}_{0} ( t ) = {\sum }_{i} {ρ}_{0 , i}^{0} {w}_{0} ( t - iT ) + {\sum }_{i} {ρ}_{1 , i}^{0} {w}_{1} ( t - iT )$$

$${s}_{1} ( t ) = {\sum }_{i} {ρ}_{0 , i}^{1} {w}_{0} ( t - iT ) + {\sum }_{i} {ρ}_{1 , i}^{1} {w}_{1} ( t - iT )$$

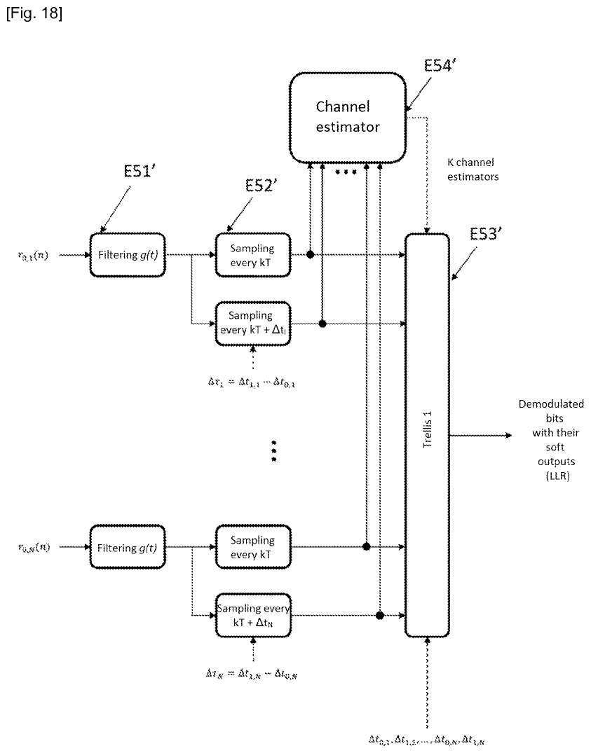

This architecture, described in FIG. 18, then has the advantage of being able to estimate the different parameters of the propagation channels and inject these estimates at the time of demodulation.

A notable difference with respect to the architecture of the first embodiment lies in the fact that it is not necessary to feed the demodulator with the estimates of the channel gains h_{0,1}, h_{1,1}, . . . , h_{0,N}, h_{1,N} insofar as this step is done in the demodulator.

This architecture has N inputs corresponding to the N sequences of samples r_{0,1}(n), . . . , r_{0,N}(n) feeding the demodulator. This architecture also requires the estimates of the delays Δt_{0,1}, Δt_{1,1}, . . . , Δt_{0,N}, Δt_{1,N}. At the output of this demodulation architecture, this gives a sequence of soft-output demodulated bits (LLR).

The sequence of samples r_{0,I}(n) with I varying from 1 to N is first filtered by a filter used to optimize the signal-to-noise ratio at the demodulation input. This filter can be simply a matched filter.

Using the parameters Δt_{0,I} and Δt_{1,I}, the signal r_{0,I}(n) is sampled firstly at the times kT and secondly at the times kT+Δt_{I}. This respectively gives the sequences of samples y_{I}(k) and y_{Δτ}_{_{I}}(k).

The sequences y₁(k), y_{Δτ}_{₁}(k), . . . , y_{N}(k),y_{Δτ}_{_{N}}(k) then feed a channel estimating method.

The aim of this method is to provide K channel estimates to the trellis 1.

By writing L the number of bits involved in the space-time coding, the trellis used then has 2^{mL} states and 2^{2mL} branches where m is a variable parameter dependent on the impulse response of the propagation channel.

The sequences y₁(k), y_{Δτ}_{_{I}}(k), . . . , y_{N}(k),y_{Δτ}_{_{N}}(k), coupled to the K channel estimates resulting from the channel estimating method, feed the trellis 1. This method also requires the knowledge of the parameters Δt_{0,1}, Δt_{1,1}, . . . , Δt_{0,N}, Δt_{1,N}.

The use of this trellis then makes it possible to estimate the most probable binary sequence transmitted. Moreover, the use of a single trellis having a fixed number of states makes it possible to compute LLRs.

The computation of the LLRs on the information bits can then be done by way of a SOVA (Soft Output Viterbi Algorithm). The description of this algorithm is given in the document [A3].

The advantages of this architecture are several.

1. The presence of the filter for reducing the inter-symbol interference present at the input of the demodulator makes it possible to greatly reduce the complexity of the equalization blocks and to simplify the trellis used for the Viterbi algorithm.

2. The particular decomposition of the CPM signal in the form of a modulation of OQPSK type has the consequence of enabling the use of a fixed trellis.

3. The channel estimator makes it possible to estimate multi-path channels.

4. The channel estimates provided to the demodulation trellis then make it possible to equalize the received signal.

5. The single and fixed trellis used in the Viterbi algorithm has the advantage of using an algorithm of SOVA type in order to compute the LLRs on the demodulated bits.

6. The whole of the demodulation method is more robust to the effects of the multi-path channels by comparison with the solution of the prior art.

7. Even without a channel decoder for decoding the LLRs, the use of a hard decision by extraction of the “Most Significant Bit” (MSB) on the LLRs leads to an improvement in performance.

In the special case of STC-SOQPSK based on the IRIG-106 recommendation, supposing that the frequency offset has been perfectly corrected, the received signal can be written as follows after the steps of filtering by g and sampling:

$$y ( k ) \approx {\sum }_{m = 0}^{1} {\sum }_{i = - \frac{{N}_{t}^{m} - 1}{2}}^{\frac{{N}_{t}^{m} - 1}{2}} {ρ}_{m , k - i}^{0} {\tilde{f}}_{m}^{0} ( i ) + {\sum }_{m = 0}^{1} {\sum }_{i = - \frac{{N}_{t}^{m} - 1}{2}}^{\frac{{N}_{t}^{m} - 1}{2}} {ρ}_{m , k - i}^{1} {\tilde{f}}_{m}^{1 , Δτ} ( i ) + z ( kT + {Δτ}_{0} )$$

$${y}_{Δτ} ( k ) \approx {\sum }_{m = 0}^{1} {\sum }_{i = - \frac{{N}_{t}^{m} - 1}{2}}^{\frac{{N}_{t}^{m} - 1}{2}} {ρ}_{m , k - i}^{0} {\tilde{f}}_{m}^{0 , Δτ} ( i ) + {\sum }_{m = 0}^{1} {\sum }_{i = - \frac{{N}_{t}^{m} - 1}{2}}^{\frac{{N}_{t}^{m} - 1}{2}} {ρ}_{m , k - i}^{1} {\tilde{f}}_{m}^{1} ( i ) + z ( kT + {Δτ}_{1} )$$

where:
Δτ=Δτ₁−Δτ₀ où Δτ₀ is the delay of the direct path from the antenna 1 and Δτ₁ is the delay of the direct path from the antenna 2. Δτ is the time offset.
Δε is the closest integer to the division of Δτ by T.
The values \tilde{f}ₘ^{p}(i) and \tilde{f}ₘ^{p,Δτ}(i) are defined as follows:

\tilde{f}ₘ^{p}(i)=\tilde{f}ₘ^{p}(t=iT)

\tilde{f}ₘ^{0,Δτ}(i)=\tilde{f}ₘ⁰(t=iT+ΔεT)

\tilde{f}ₘ^{1,Δτ}(i)=\tilde{f}ₘ⁰(t=iT−ΔεT)

with

\tilde{f}ₘ^{p}(t)=∫fₘ^{k}(θ)g(θ−t)dθ

and

$${f}_{m}^{0} ( t ) = {w}_{m} ( t ) * ( {h}_{0} δ ( t ) + {\sum }_{i = 1}^{{N}_{0}} {h}_{2 i} δ ( t - ( {Δτ}_{2 i} - {Δτ}_{0} ) ) ) , m ∈ \{ 0 , 1 \}$$

$${f}_{m}^{1} ( t ) = {w}_{m} ( t ) * ( {h}_{1} δ ( t ) + {\sum }_{i = 1}^{{N}_{1}} {h}_{2 i + 1} δ ( t - ( {Δτ}_{2 i + 1} - {Δτ}_{1} ) ) ) , m ∈ \{ 0 , 1 \}$$

δ(t) is the Dirac pulse centered on 0.
Nₜ^{m} is the length of the filters \tilde{f}ₘ⁰, \tilde{f}ₘ^{0,Δτ}, \tilde{f}ₘ¹, \tilde{f}ₘ^{1,Δτ},
z is an additive noise
ρ_{0,i}⁰, ρ_{0,i}¹, ρ_{1,i}⁰, ρ_{1,i}¹ are pseudo-symbols the analytical expression of which is respectively:

$${ρ}_{0 , i}^{p} = \{ \begin{matrix}( 2 {b}_{i}^{( p )} - 1 ) & if i is even \\ j ( 2 {b}_{i}^{( p )} - 1 ) & if i is odd\end{matrix} \\ {ρ}_{1 , i}^{p} = \{ \begin{matrix}- j ( 2 {b}_{i - 2}^{( p )} - 1 ) ( 2 {b}_{i - 1}^{( p )} - 1 ) ( 2 {b}_{i}^{( p )} - 1 ) & if i is even \\ - ( 2 {b}_{i - 2}^{( p )} - 1 ) ( 2 {b}_{i - 1}^{( p )} - 1 ) ( 2 {b}_{i}^{( p )} - 1 ) & if i is odd\end{matrix}$$

bᵢ⁽⁰⁾ and bᵢ⁽¹⁾ are respectively the information bits feeding the SOQPSK modulator of the path 1 and the path 2, each channel corresponding to the antennas A1, A2.

It is recalled that bᵢ⁽⁰⁾ and bᵢ⁽¹⁾ are linked between them by way of the binary rearrangement code defined in the IRIG-106 recommendation. The binary rearrangement code constructs on the basis of the sequence b=b₄k, b₄ₖ₊₁, b₄ₖ₊₂, b₄ₖ₊₃, . . . the sequences:

bᵤ⁽⁰⁾= . . . b₄ₖ⁽⁰⁾,b₄ₖ₊₁⁽⁰⁾,b₄ₖ₊₂⁽⁰⁾,b_{4k+3′}⁽⁰⁾, . . . = . . . b₄ₖ,b_{4k+1,}b̅_{4k+2,}b₄ₖ₊₃, . . .

bᵤ⁽¹⁾= . . . b₄ₖ⁽¹⁾,b₄ₖ₊₁⁽¹⁾,b₄ₖ₊₂⁽¹⁾,b_{4k+3′}⁽¹⁾, . . . = . . . b₄ₖ₊₂,b_{4k+3,}b_{4k,}b̅₄ₖ₊₁, . . .

where the operation x̅ represents the operation of binary inversion of the bit x.

The filtering operations make it possible to reduce the inter-symbol interference and the sampling operations are the same as those described in the architecture 1.

The channel estimation operation that takes as input the signal thus sampled can thus be produced by way of the method used in the literature (for this see the document [A3]) However, in the presence of multi-path channels, this reference method is no longer appropriate.

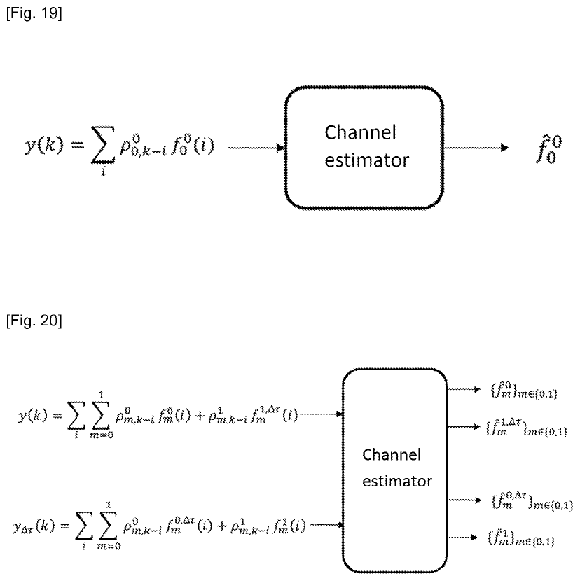

In the literature, the channel estimation methods have architectures as described in FIG. 19. As an input to this estimator, a sequence is injected of the form

$$y ( k ) = {\sum }_{i} {ρ}_{0 , k - i}^{0} {f}_{0}^{0} ( i )$$

and this estimator provides us with an estimate of \hat{f}₀⁰.

An example of such a method as well as many derivative techniques is described in [A7].
[A7] B. Farhang-Boroujeny, Adaptive Filters, Wiley, 1998.

However this structure has limits due to the fact that the received signal is a sum of modulations, the previous estimators are not appropriate as they only make it possible to estimate a single parameter at a time, whereas our formulation of the problem involves the estimation of 8 parameters at once.

In this context, the following channel estimation method is proposed.

This channel estimation method is described in FIG. 20. One injects into the method the samples y(k) and y_{Δτ}(k) and retrieves at the output the 8 filters \tilde{f}ₘ⁰, \tilde{f}ₘ^{0,Δτ}, \tilde{f}ₘ¹, \tilde{f}ₘ^{1,Δτ}, (m∈{−1,1}) with i varying by

$$- \frac{{N}_{t}^{m} - 1}{2} to \frac{{N}_{t}^{m} - 1}{2} .$$

The following special relationship exists:

Nₜ¹=Nₜ⁰−2=Nₜ−2

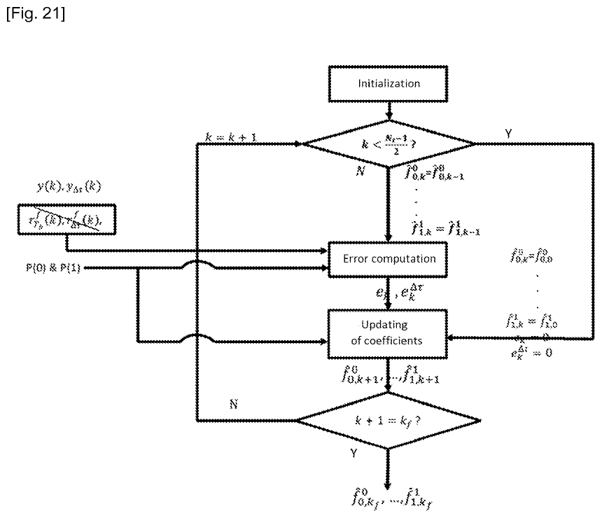

The channel estimation method is done recursively and is described in FIG. 21. If the iteration is written k, the estimate of the filters with iteration k is then called \tilde{f}ₘ⁰, \tilde{f}ₘ^{0,Δτ}, \tilde{f}ₘ¹, \tilde{f}ₘ^{1,Δτ}.

An initialization of these 8 filters is first carried out. This step involves the initialization of the vectors \hat{f}_{0,0}⁰, \hat{f}_{0,0}¹, \hat{f}_{0,0}^{0,Δτ}, \hat{f}_{0,0}^{1,Δτ} (respectively \hat{f}_{1,0}⁰, \hat{f}_{1,0}¹, \hat{f}_{1,0}^{0,Δτ}, \hat{f}_{1,0}^{1,Δτ}) of size Nₜ (or Nₜ−2) with the eight filters estimated by the pilot sequence of the previous frame (i.e. \hat{f}_{0,k}_{_{f}}⁰, . . . , \hat{f}_{1,k}_{_{f}}¹ of the previous frame). For the first frame, the filters are initialized in this way (a frame is a binary sequence composed of a pilot sequence of length Lₚ followed by a sequence of useful data of size L_{d}:

This gives:

$$\{ \begin{matrix}{\hat{f}}_{0 , 0}^{0} ( i ) = {w}_{0} ( {iT}_{b} ) , & for i = - \frac{{N}_{t} - 1}{2} , … , \frac{{N}_{t} - 1}{2} \\ {\hat{f}}_{1 , 0}^{0} ( i ) = {w}_{1} ( {iT}_{b} ) , & for i = - \frac{{N}_{t} - 3}{2} , … , \frac{{N}_{t} - 3}{2} \\ {\hat{f}}_{0 , 0}^{1 , Δτ} = {w}_{0} ( ( i - Δτ ) {T}_{b} ) , & for i = - \frac{{N}_{t} - 1}{2} , … , \frac{{N}_{t} - 1}{2} \\ {\hat{f}}_{1 , 0}^{1 , Δτ} = {w}_{1} ( ( i - Δτ ) {T}_{b} ) , & for i = - \frac{{N}_{t} - 3}{2} , … , \frac{{N}_{t} - 3}{2} \\ {\hat{f}}_{0 , 0}^{0 , Δτ} ( i ) = {w}_{0} ( ( i + Δτ ) {T}_{b} ) , & for i = - \frac{{N}_{t} - 1}{2} , … , \frac{{N}_{t} - 1}{2} \\ {\hat{f}}_{1 , 0}^{0 , Δτ} ( i ) = {w}_{1} ( ( i + Δτ ) {T}_{b} ) , & for i = - \frac{{N}_{t} - 3}{2} , … , \frac{{N}_{t} - 3}{2} \\ {\hat{f}}_{0 , 0}^{1} ( i ) = {w}_{0} ( {iT}_{b} ) , & for i = - \frac{{N}_{t} - 1}{2} , … , \frac{{N}_{t} - 1}{2} \\ {\hat{f}}_{1 , 0}^{1} ( i ) = {w}_{1} ( {iT}_{b} ) , & for i = - \frac{{N}_{t} - 3}{2} , … , \frac{{N}_{t} - 3}{2}\end{matrix}$$

Based on the preamble bits P(0) and P(1) as well as the signals y(k) and y_{Δτ}(k), two error functions are then computed, defined as follows:

$${e}_{k} = y ( k ) - ( {\sum }_{i = - \frac{( {N}_{t} - 1 )}{2}}^{i = \frac{( {N}_{t} - 1 )}{2}} {ρ}_{0 , k - i}^{0} {\hat{f}}_{0 , k}^{0} ( i ) + {\sum }_{i = - \frac{( {N}_{t} - 3 )}{2}}^{i = \frac{( {N}_{t} - 3 )}{2}} {ρ}_{1 , k - i}^{0} {\hat{f}}_{1 , k}^{0} ( i ) + {\sum }_{i = - \frac{( {N}_{t} - 1 )}{2}}^{i = \frac{( {N}_{t} - 1 )}{2}} {ρ}_{0 , k - i}^{1} {\hat{f}}_{0 , k}^{1 , Δτ} ( i ) + {\sum }_{i = - \frac{( {N}_{t} - 3 )}{2}}^{i = \frac{( {N}_{t} - 3 )}{2}} {ρ}_{1 , k - i}^{1} {\hat{f}}_{1 , k}^{1 , Δτ} ( i ) )$$

$${e}_{k}^{Δτ} = {y}_{Δτ} ( k ) - ( {\sum }_{i = - \frac{( {N}_{t} - 1 )}{2}}^{i = \frac{( {N}_{t} - 1 )}{2}} {ρ}_{0 , k - i}^{0} {\hat{f}}_{0 , k}^{0 , Δτ} ( i ) + {\sum }_{i = - \frac{( {N}_{t} - 3 )}{2}}^{i = \frac{( {N}_{t} - 3 )}{2}} {ρ}_{1 , k - i}^{0} {\hat{f}}_{1 , k}^{0 , Δτ} ( i ) + {\sum }_{i = - \frac{( {N}_{t} - 1 )}{2}}^{i = \frac{( {N}_{t} - 1 )}{2}} {ρ}_{0 , k - i}^{1} {\hat{f}}_{0 , k}^{1} ( i ) + {\sum }_{i = - \frac{( {N}_{t} - 3 )}{2}}^{i = \frac{( {N}_{t} - 3 )}{2}} {ρ}_{1 , k - i}^{1} {\hat{f}}_{1 , k}^{1} ( i ) )$$

$$for k = \frac{{N}_{t} - 1}{2} , … , {k}_{f} with {k}_{f} = {L}_{p} - 1 - \frac{{N}_{t} - 1}{2} .$$

The updating of the coefficients of the filters can be done by various estimation algorithms, the most conventional of which are as follows:
The LMS (Least Mean Square) algorithm
The RLS (Recursive Least Square) algorithm
Kalman filtering
Any algorithm derived from the previous techniques.

In the special case of use of the LMS algorithm, it is necessary to proceed as follows.

On the basis of these error functions and the preamble bits P(0) and P(1), the coefficients of the eight filters are updated as follows:

$$\{ \begin{matrix}{\hat{f}}_{0 , k + 1}^{0} ( i ) = {\hat{f}}_{0 , k}^{0} ( i ) + μ \times {e}_{k} \times {( {ρ}_{0 , k - i}^{0} )}^{*} , & for i = - \frac{{N}_{t} - 1}{2} , … , \frac{{N}_{t} - 1}{2} \\ {\hat{f}}_{1 , k + 1}^{0} ( i ) = {\hat{f}}_{1 , k}^{0} ( i ) + μ \times {e}_{k} \times {( {ρ}_{1 , k - i}^{0} )}^{*} , & for i = - \frac{{N}_{t} - 3}{2} , … , \frac{{N}_{t} - 3}{2} \\ {\hat{f}}_{0 , k + 1}^{1 , Δτ} ( i ) = {\hat{f}}_{0 , k}^{1 , Δτ} ( i ) + μ \times {e}_{k} \times {( {ρ}_{0 , k - i}^{1} )}^{*} , & for i = - \frac{{N}_{t} - 1}{2} , … , \frac{{N}_{t} - 1}{2} \\ {\hat{f}}_{1 , k + 1}^{1 , Δτ} ( i ) = {\hat{f}}_{1 , k}^{1 , Δτ} ( i ) + μ \times {e}_{k} \times {( {ρ}_{1 , k - i}^{1} )}^{*} , & for i = - \frac{{N}_{t} - 3}{2} , … , \frac{{N}_{t} - 3}{2}\end{matrix} \\ \{ \begin{matrix}{\hat{f}}_{0 , k + 1}^{0 , Δτ} ( i ) = {\hat{f}}_{0 , k}^{0 , Δτ} ( i ) + μ \times {e}_{k} \times {( {ρ}_{0 , k - i}^{0} )}^{*} , & for i = - \frac{{N}_{t} - 1}{2} , … , \frac{{N}_{t} - 1}{2} \\ {\hat{f}}_{1 , k + 1}^{0 , Δτ} ( i ) = {\hat{f}}_{1 , k}^{0 , Δτ} ( i ) + μ \times {e}_{k} \times {( {ρ}_{1 , k - i}^{0} )}^{*} , & for i = - \frac{{N}_{t} - 3}{2} , … , \frac{{N}_{t} - 3}{2} \\ {\hat{f}}_{0 , k + 1}^{1} ( i ) = {\hat{f}}_{0 , k}^{1} ( i ) + μ \times {e}_{k} \times {( {ρ}_{0 , k - i}^{1} )}^{*} , & for i = - \frac{{N}_{t} - 1}{2} , … , \frac{{N}_{t} - 1}{2} \\ {\hat{f}}_{1 , k + 1}^{1} ( i ) = {\hat{f}}_{1 , k}^{1} ( i ) + μ \times {e}_{k} \times {( {ρ}_{1 , k - i}^{1} )}^{*} , & for i = - \frac{{N}_{t} - 3}{2} , … , \frac{{N}_{t} - 3}{2}\end{matrix}$$

with μ the adaptive increment (its value is constant and fixed beforehand), the operator ( )* shows the complex conjugate.

After this channel estimating step, the estimates thus obtained are injected along with the samples y(k) and y_{Δτ}(k) into a Trellis 1 which has the aim of detecting the most probable binary sequence and estimating the LLRs on each information bit.

The principle of construction of the trellis is strictly identical to that described in the generic architecture.

A Viterbi algorithm is used seeking to find the best sequence of bits Ŝ making it possible to solve the following problem:

$$\underline{\hat{S}} = {argmin}_{S} Λ ( \underline{S} )$$

$$with : \\ Λ ( \underline{S} ) = {\sum }_{n = 0}^{( N - 1 ) / 4} ( {\sum }_{m = - 1}^{2} [ {\vert {B}_{m , n}^{( 0 )} \vert}^{2} + {\vert {B}_{m , n}^{( Δ r )} \vert}^{2} ] )$$

$$with : \\ {B}_{m , n}^{0} = y ( 4 n + m ) - ( {\sum }_{i = - \frac{( {N}_{t} - 1 )}{2}}^{i = \frac{( {N}_{t} - 1 )}{2}} {ρ}_{0 , 4 n + m - i}^{0} {\hat{f}}_{0 , {n}_{p}}^{0} ( i ) + {\sum }_{i = - \frac{( {N}_{t} - 3 )}{2}}^{i = \frac{( {N}_{t} - 3 )}{2}} {ρ}_{1 , 4 n + m}^{0} {\hat{f}}_{1 , {n}_{p}}^{0} ( i ) + {\sum }_{i = - \frac{( {N}_{t} - 1 )}{2}}^{i = \frac{( {N}_{t} - 1 )}{2}} {ρ}_{0 , 4 n + m - i}^{1} {\hat{f}}_{0 , {n}_{p}}^{1 , Δτ} ( i ) + {\sum }_{i = - \frac{( {N}_{t} - 3 )}{2}}^{i = \frac{( {N}_{t} - 3 )}{2}} {ρ}_{1 , 4 n + m}^{1} {\hat{f}}_{1 , {n}_{p}}^{1 , Δτ} ( i ) )$$

$${B}_{m , n}^{( Δτ )} = {y}_{Δτ} ( 4 n + m ) - ( {\sum }_{i = - \frac{( {N}_{t} - 1 )}{2}}^{i = \frac{( {N}_{t} - 1 )}{2}} {ρ}_{0 , 4 n + m - i}^{0} {\hat{f}}_{0 , {n}_{p}}^{0 , Δτ} ( i ) + {\sum }_{i = - \frac{( {N}_{t} - 3 )}{2}}^{i = \frac{( {N}_{t} - 3 )}{2}} {ρ}_{1 , 4 n + m}^{0} {\hat{f}}_{1 , {n}_{p}}^{0 , Δτ} ( i ) + {\sum }_{i = - \frac{( {N}_{t} - 1 )}{2}}^{i = \frac{( {N}_{t} - 1 )}{2}} {ρ}_{0 , 4 n + m - i}^{1} {\hat{f}}_{0 , {n}_{p}}^{1} ( i ) + {\sum }_{i = - \frac{( {N}_{t} - 3 )}{2}}^{i = \frac{( {N}_{t} - 3 )}{2}} {ρ}_{1 , 4 n + m}^{1} {\hat{f}}_{1 , {n}_{p}}^{1} ( i ) )$$

The information bits are thus retrieved using a Viterbi algorithm associated with the trellis illustrated in FIG. 17.

The trellis under consideration describes the transitions from a state Sₙ=[b₄ₙ b₄ₙ₊₁ b₄ₙ₊₂ b₄ₙ₊₃] to a state Sₙ₊₁=[b₄ₙ₊₄ b₄ₙ₊₅ b₄ₙ₊₆ b₄ₙ₊₇]. The transitions are weighted via the following branch metric:

$$λ ( {S}_{n - 1} ( i ) \to {S}_{n} ( j ) ) = {\sum }_{m = - 1}^{2} [ {\vert {B}_{m , n}^{( 0 )} \vert}^{2} + {\vert {B}_{m , n}^{( Δ τ )} \vert}^{2} ]$$

The trellis therefore includes 16 states, describing the 16 possible states of the variable Sₙ. The number of branches to be computed is then of 256.

The use of the trellis associated with this architecture therefore allows, using the branch metrics defined above, the use of a SOVA-type algorithm in order to compute the LLRs on the information bits.

The way of obtaining the LLRs on the information bits is identical to that used in the first embodiment.

### 6) Third Embodiment—Architecture Including an Equalization Method Before Demodulation by the Viterbi Algorithm

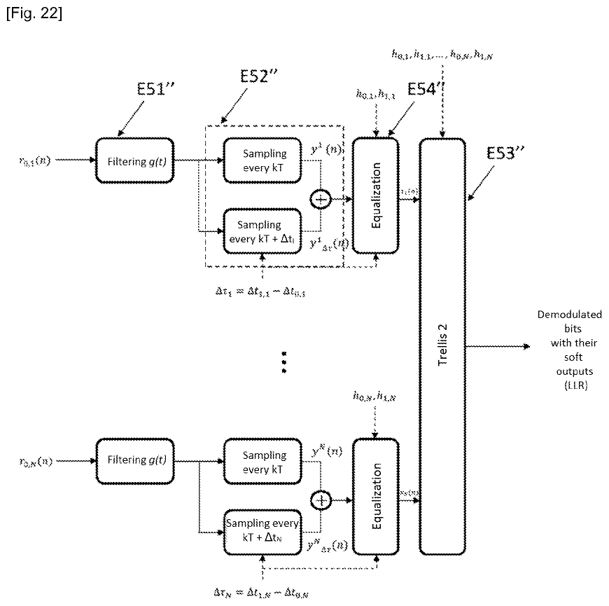

This demodulation architecture is described in FIG. 22. This architecture has N inputs corresponding to the N sequences of samples r_{0,1}(n), . . . , r_{0,N}(n) that feed the demodulator. This architecture also requires the estimates of the delays Δt_{0,1}, Δt_{1,1}, . . . , Δt_{0,N},Δt_{1,N} as well as the estimates of the channel gains h_{0,1}, h_{1,1}, . . . , h_{0,N}, h_{1,N}. At the output of this demodulation architecture, this gives a sequence of soft-output demodulated bits (LLR).

The sequence of samples r_{0,I}(n) with I varying from 1 to N is first filtered by a filter making it possible to optimize the signal-to-noise ratio. It is then possible to use a simple matched filter.

Using the parameters Δt_{0,I} and Δt_{1,I}, the signal is firstly sampled at the times kT and secondly at the times kT+Δt_{I}. This then gives the sequences of samples y_{I}(k) and y_{Δτ}_{_{I}}(k) respectively.

The sum y_{I}(k)+y_{Δτ}_{_{I}}(k) then feeds an equalization method which, using the estimates of the channel gains h_{0,I} and h_{1,I} makes it possible to obtain a vector x_{I} which is input into a trellis 2.

The fact of using the sum y_{I}(k)+y_{Δτ}_{_{I}}(k) as an equalization input has the advantage of simply formulating the equalization method.

The values of the vector x_{I} are then adapted to the use of a single trellis having a number of fixed states.

The use of this trellis then makes it possible to estimate the most probable transmitted binary sequence. Moreover, the use of a single trellis having a fixed number of states makes it possible to compute LLRs.

The computation of the LLRs on the information bits can then be performed by way of a SOVA (Soft Output Viterbi Algorithm). The description of this algorithm is given in the document [A3].

The advantages of this architecture are several.

1. The presence of the filter for reducing the inter-symbol interference present at the input of the demodulator makes it possible to greatly reduce the complexity of the equalization blocks and to simplify the trellis used for the Viterbi algorithm.

2. The particular decomposition of the CPM signal in the form of a modulation of OQPSK type has the consequence of enabling the use of an equalization algorithm upstream of the trellis and the use of a fixed trellis.

3. The presence of the equalization block makes it possible to feed the trellis with optimized data that make it possible to use a maximum likelihood criterion in the Viterbi algorithm.

4. The single and fixed trellis used in the Viterbi algorithm has the advantage of using an algorithm of SOVA type to compute the LLRs on the demodulated bits.

5. Even without a channel decoder for decoding the LLRs, the use of a hard decision by extraction of the Most Significant Bit (MSB) on the LLRs leads to an improvement in performance.

In the special case of STC-SOQPSK based on the IRIG-106 recommendation, it is possible to write the received signal at the input of the demodulator in the following approximate form, supposing that the frequency offset has been perfectly corrected:

$${r}_{0} ( n ) \approx {h}_{0} \underbrace{{\sum }_{i} {ρ}_{0 , i}^{0} {w}_{0} ( {nT}^{′} - iT )}_{{s}_{0} ( {nT}^{′} )} + {h}_{1} \underbrace{{\sum }_{i} {ρ}_{0 , i}^{1} {w}_{0} ( {nT}^{′} - iT - Δ τ )}_{{s}_{1} ( {nT}^{′} - Δτ )} + z ( {nT}^{′} )$$

where:
T′ is the sampling time of the analog-to-digital converter (consequently T′<<T)
w₀ is the main pulse of the decomposition of the CPM signal in the form of OQPSK modulation
h₀, h₁ and Δτ, are respectively the channel gain resulting from the propagation between the transmitting antenna 1 and the receiving antenna, the channel gain resulting from the propagation between the transmitting antenna 2 and the receiving antenna and the time offset defined as Δτ=Δt₁−Δt₀.
z is additive noise
ρ_{0,i}⁰ and ρ_{0,i}¹ are pseudo-symbols for which the analytical expression is respectively:

$${ρ}_{0 , i}^{p} = \{ \begin{matrix}( 2 {b}_{i}^{( p )} - 1 ) & if i is even \\ j ( 2 {b}_{i}^{( p )} - 1 ) & if i is odd\end{matrix}$$

bᵢ⁽⁰⁾ and bᵢ⁽¹⁾ are respectively the information bits feeding the SOQPSK modulator of path 1 and path 2.

It should be noted here that the expression r₀(n) depends only on the main pulse w₀, which is predominant with respect to the pulse w₁ which is negligible.

It will be recalled that bᵢ⁽⁰⁾ and bᵢ⁽¹⁾ are connected to one another by way of the binary rearrangement code defined in the IRIG-106 recommendation. The binary rearrangement code constructs on the basis of the sequence b= . . . b₄ₖ, b₄ₖ₊₁, b₄ₖ₊₂, b₄ₖ₊₃, . . . the sequences:

bᵤ⁽⁰⁾= . . . b₄ₖ⁽⁰⁾,b₄ₖ₊₁⁽⁰⁾,b₄ₖ₊₂⁽⁰⁾,b_{4k+3′}⁽⁰⁾, . . . = . . . b₄ₖ,b_{4k+1,}b̅_{4k+2,}b₄ₖ₊₃, . . .

bᵤ⁽¹⁾= . . . b₄ₖ⁽¹⁾,b₄ₖ₊₁⁽¹⁾,b₄ₖ₊₂⁽¹⁾,b_{4k+3′}⁽¹⁾, . . . = . . . b₄ₖ₊₂,b_{4k+3,}b_{4k,}b̅₄ₖ₊₁, . . .

where the operation x̅ represents the operation of binary inversion of the bit x. Finally one writes βᵢ the symbol of the alphabet {+1, −1} defined by:

βᵢ=2bᵢ−1

The samples r₀(n) are then filtered by a filter making it possible to reduce the inter-symbol interference. Specifically, as w₀ is a pulse having a time base larger than T, an inter-symbol interference is present in the received signal.

This filter must have the following features:
It must not color the noise component present in the received signal
It must have a bandwidth wider than that of the useful signal.
It must reduce the inter-symbol interference.

A matched filter can be sufficient. However, it has the drawback of introducing high levels of inter-symbol interference.

Different filters satisfying the conditions above are possible. The reference [A8] shows several filters that can be used in this scenario.
[A8] Geoghegan, Mark, “Optimal Linear Detection of SOQPSK,” in International Telemetering Conference Proceedings, October 2002

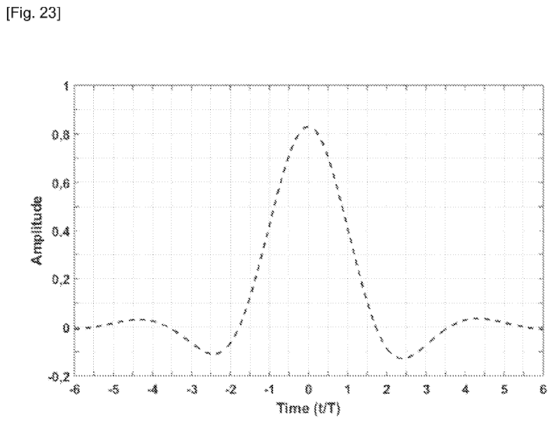

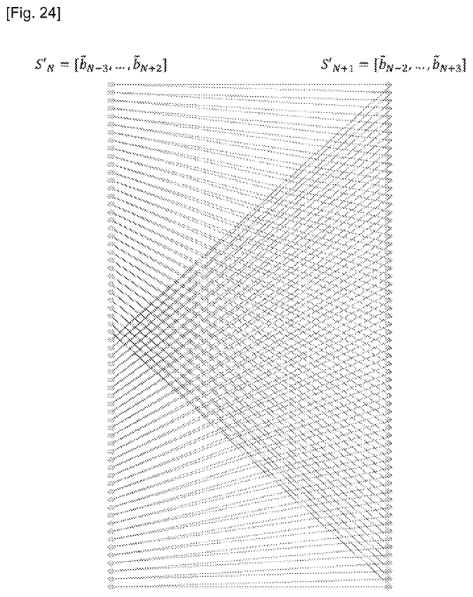

The filter g shown in FIG. 23 has been determined such as to satisfy the conditions above.

This filter is composed of a matched filter at w₀ and a Wiener filter constructed using the MMSE (Minimum Mean Square Error) criterion to reduce the inter-symbol interference introduced by w₀. The coefficients of the Wiener filter c_{wf} are computed using the method given in [A9].
[A9]: G. K. Kaleh, “Simple coherent receivers for partial response continuous phase modulation,” in IEEE Journal on Selected Areas in Communications, vol. 7, no. 9, pp. 1427-1436, December 1989.

The filter g is therefore given by the following formula: g(t)=Σ_{k=-∞}^{+∞}c_{wf}(k)w₀(−t+2kT)

Thus, at the output of this filter and after the operations of sampling at the symbol rate, we have:

$$y ( 4 k ) = {h}_{0} {\sum }_{i = - 1}^{1} {ρ}_{0 , 4 k - i}^{0} {\tilde{w}}_{0} ( i T ) + {h}_{1} {\sum }_{i = - 1}^{1} {ρ}_{0 , 4 k - i}^{1} {\tilde{w}}_{0} ( iT - Δ ɛ T ) + \tilde{n} ( 4 kT )$$

$${y}_{Δ τ} ( 4 k ) = {h}_{0} {\sum }_{i = - 1}^{1} {ρ}_{0 , 4 k - i}^{0} {\tilde{w}}_{0} ( i T + Δ ɛ T ) + {h}_{1} {\sum }_{i = - 1}^{1} {ρ}_{0 , 4 k - i}^{1} {\tilde{w}}_{0} ( iT ) + \tilde{n} ( 4 kT + Δ ɛ T )$$

where \tilde{w}₀ is the result of the convolution product between the pulse w₀ and the filter g, ñ is the result of the convolution product between the noise z and the filter g and Δε being the integer closest to the division of Δτ by T.

The possibility of using an equalization technique comes from the fact that the following metric is considered at its input:

Bₘ^{k}=½(y(4k+m)+y_{Δτ}(4k+m))

This metric has the advantage of taking into account the time offset Δτ.

Moreover, the knowledge of the estimates h₀ and h₁ make it possible to construct the following matrix:

$$H = [ \begin{matrix}{h}_{0} & {h}_{1} \\ {h}_{1}^{*} & - {h}_{0}^{*}\end{matrix} ]$$

with x* the operation of conjugation of the complex number x.

One then defines:

$$[ \begin{matrix}{l}_{0}^{k} \\ {l}_{1}^{k}\end{matrix} ] = Re ( {H}^{H} [ \begin{matrix}{B}_{0}^{k} \\ {B}_{1}^{k}\end{matrix} ] ) \\ [ \begin{matrix}{l}_{2}^{k} \\ {l}_{3}^{k}\end{matrix} ] = Im ( {H}^{H} [ \begin{matrix}{B}_{2}^{k} \\ {B}_{3}^{k}\end{matrix} ] )$$

with Re(x) the real part of x, Im(x) the imaginary part of x and H^{H} the conjugate transpose of the matrix H.

Then setting:

x=(l₀⁰,l₂⁰,l₁⁰,l₃⁰,l₀¹,l₂¹,l₁¹,l₃¹, . . . ,l₀^{K-1},l₂^{K-1},l₁^{K-1},l₃^{K-1})^{T}

x=(β₀,β₁,β₂,β₃,β₄,β₅,β₆,β₇, . . . ,β_{4K-4},β_{4K-3},β_{4K-2},β_{4K-1})^{T}

with ^{T} the operation of transposition of a vector. This gives the relationship:

x=Gb+u

where G is a matrix of size 4K×4K and u is a noise vector.

The main interest of this formulation above is that it is possible to use an algorithm of estimation by likelihood maximum to estimate the most probable sequence b.

The formulation of the problem consists in maximizing the following expression of the likelihood:

Λ(x,b)=2b^{T}x−b^{T}Gb

The maximization of this value is therefore done conventionally by way of a Viterbi algorithm. This Viterbi algorithm uses the trellis 2 composed of 64 states and 128 branches shown in FIG. 24. The following branch metrics are used:

$$λ ( n ) = \{ \begin{matrix}{β}_{n} ( 2 {x}_{n} - ( D - C ) ζ {β}_{n + 3} - C ζ {β}_{n + 1} - D ζ {β}_{n - 3} ) - A χ {\vert {β}_{n} \vert}^{2} & if n = 4 k \\ {β}_{n} ( 2 {x}_{n} - ( D - C ) ζ {β}_{n + 1} - C {ζβ}_{n - 1} - D {ζβ}_{n + 3} ) - A χ {\vert {β}_{n} \vert}^{2} & if n = 4 k + 1 \\ {β}_{n} ( 2 {x}_{n} - ( D - C ) ζ {β}_{n - 1} - D {ζβ}_{n + 1} - D {ζβ}_{n - 3} ) - A χ {\vert {β}_{n} \vert}^{2} & if n = 4 k + 2 \\ {β}_{n} ( 2 {x}_{n} - D {ζβ}_{n - 1} - C {ζβ}_{n + 3} ) - A χ {\vert {β}_{n} \vert}^{2} & if n = 4 k + 3\end{matrix} \\ with \\ χ = {\vert {h}_{0} \vert}^{2} + {\vert {h}_{1} \vert}^{2} \\ ζ = Im ( {h}_{0}^{*} {h}_{1} ) \\ A = \frac{1}{2} ( {\tilde{w}}_{0} ( 0 ) + {\tilde{w}}_{0} ( Δ ɛ T ) ) \\ C = \frac{1}{2} ( {\tilde{w}}_{0} ( - T ) + {\tilde{w}}_{0} ( - T + Δ ɛ T ) ) \\ D = \frac{1}{2} ( {\tilde{w}}_{0} ( T ) + {\tilde{w}}_{0} ( T + Δ ɛ T ) )$$

The use of the trellis associated with this architecture therefore makes it possible, using the branch metrics defined above, to use an algorithm of SOVA type in order to compute the LLRs on the information bits.

The way of obtaining the LLRs on the information bits is identical to the procedure described in the generic architecture.

1. A method for receiving a CPM signal with space-time coding, said signal being an SOQPSK-TG signal based on the IRIG-106 recommendation transmitted from two transmitting antennas A1, A2 the received signal modulating a plurality of bits bᵢ^{(j)} j=0 or 1 and corresponding to the bits transmitted over the antenna A1 and A2 respectively, said received signal having a time offset Δτ taking into account the time offset between the signals transmitted from each antenna A1, A2, said signal being received over one or more receiver antennas A3;
obtaining over one antenna a sampled digital signal y(k) and its offset version y_{Δτ}(k) taking into account the time offset between the two transmitting antennas, each comprising the contributions of the signals output by the two transmitting antennas, said digital signals being able to be expressed according to the following decomposition
$${s}_{p} ( t ) \approx {\sum }_{i} {ρ}_{0 , 2 i}^{p} {w}_{0} ( t - 2 i {T}_{b} ) - {ρ}_{1 , 2 i + 1}^{p} {w}_{1} ( t - 2 i {T}_{b} - {T}_{b} ) + ( {\sum }_{i} {ρ}_{02 i + 1}^{p} {w}_{0} ( t - 2 i {T}_{b} - {T}_{b} ) - {ρ}_{1 , 2 i}^{p} {w}_{1} ( t - 2 {iT}_{b} ) )$$
where:
T_{b} is the duration of one bit;
p∈{0,1}
ρ_{0,i}⁰, ρ_{1,i}⁰, are pseudo-symbols corresponding to the information bits bᵢ⁽⁰⁾ transmitted over the antenna A1, ρ_{0,i}¹, ρ_{1,i}¹ are pseudo-symbols corresponding to the information bits bᵢ⁽¹⁾ transmitted over the antenna A2;
w₀(t) and w₁(t) are shaping pulses, respectively a main pulse and a secondary pulse
defining a Viterbi algorithm (Trellis 1, Trellis 2) having a fixed trellis with a number of states and metrics also a function of at least said main pulse;
obtaining, by means of said Viterbi algorithm, LLRs on the transmitted information bits.

2. The receiving method as claimed in claim 1, wherein the digital signals obtained are expressed
$$y ( k ) \approx {\sum }_{m = 0}^{1} {\sum }_{i = - \frac{{N}_{t}^{m} - 1}{2}}^{\frac{{N}_{t}^{m} - 1}{2}} {ρ}_{m , k - i}^{0} {\tilde{f}}_{m}^{0} ( i ) + {\sum }_{m = 0}^{1} {\sum }_{i = - \frac{{N}_{t}^{m} - 1}{2}}^{\frac{{N}_{t}^{m} - 1}{2}} {ρ}_{m , k - i}^{0} {\tilde{f}}_{m}^{1 , Δ τ} ( i ) + z ( kT + Δ {τ}_{0} )$$
$${y}_{Δ τ} ( k ) \approx {\sum }_{m = 0}^{1} {\sum }_{i = - \frac{{N}_{t}^{m} - 1}{2}}^{\frac{{N}_{t}^{m} - 1}{2}} {ρ}_{m , k - i}^{0} {\tilde{f}}_{m}^{0 , Δ τ} ( i ) + {\sum }_{m = 0}^{1} {\sum }_{i = - \frac{{N}_{t}^{m} - 1}{2}}^{\frac{{N}_{t}^{m} - 1}{2}} {ρ}_{m , k - i}^{1} {\tilde{f}}_{m}^{1} ( i ) + z ( kT + Δ {τ}_{1} )$$
where
Δτ=Δτ₁−Δτ₀ where Δτ₀ is the delay of the direct path from the antenna A1 and Δτ₁ is the delay of the direct path from the antenna A2, Δτ is the time offset;
Δε is the integer the closest to the division of Δτ by T;
ρ_{0,i}⁰, ρ_{1,i}⁰ are pseudo-symbols corresponding to the information bits transmitted over the antenna A1, ρ_{0,i}⁰, ρ_{1,i}⁰ are pseudo-symbols corresponding to the information bits transmitted over the antenna A2;
δ(t) is the Dirac pulse centered on 0;
Nₜ^{m} is the length of the filters \tilde{f}ₘ⁰, \tilde{f}ₘ^{0,Δτ}, \tilde{f}ₘ¹, \tilde{f}ₘ^{1,Δτ}
z is additive noise.

3. The receiving method as claimed in claim 2, wherein the values \tilde{f}ₘ⁰, \tilde{f}ₘ^{0,Δτ}, \tilde{f}ₘ¹, \tilde{f}ₘ^{1,Δτ are defined as follows}
\tilde{f}ₘ^{p}(i)=\tilde{f}ₘ^{p}(t=iT)
\tilde{f}ₘ^{0,Δτ}(i)=\tilde{f}ₘ⁰(t=iT+ΔεT)
\tilde{f}ₘ^{1,Δτ}(i)=\tilde{f}ₘ⁰(t=iT−ΔεT)
with
\tilde{f}ₘ^{p}(t)=∫fₘ^{k}(θ)g(θ−t)dθ
and
$${f}_{m}^{0} ( t ) = {w}_{m} ( t ) * ( {h}_{0} δ ( t ) + {\sum }_{i = 1}^{{N}_{0}} {h}_{2 i} δ ( t - ( Δ {τ}_{2 i} - Δ {τ}_{0} ) ) ) , m ∈ \{ 0 , 1 \}$$
$${f}_{m}^{1} ( t ) = {w}_{m} ( t ) * ( {h}_{1} δ ( t ) + {\sum }_{i = 1}^{{N}_{1}} {h}_{2 i + 1} δ ( t - ( Δ {τ}_{2 i + 1} - Δ {τ}_{1} ) ) ) , m ∈ \{ 0 , 1 \}$$
where N₀, N₁ are the number of multiple paths respectively coming from the antenna A1 and the antenna A2.

4. The method as claimed in claim 3, comprising prior to the step of obtaining the signals y(k) and its offset version y_{Δτ}(k) a step (E51) of filtering the received signal by means of a Finite Impulse Response (FIR) low-pass filter of Equiripple type digitally constructed such that the normalized cut-off frequency is 0.45.

5. The method as claimed in claim 1, wherein in the absence of multiple paths, the digital signals obtained are grouped into groups of 4 samples and are expressed
$$y ( 4 k ) = {h}_{0} {\sum }_{i = - 1}^{1} {ρ}_{0 , 4 k - i}^{0} {\tilde{w}}_{0} ( i T ) + {h}_{0} {ρ}_{1 , 4 k}^{0} {\tilde{w}}_{1} ( 0 ) + {h}_{1} {\sum }_{i = - 1}^{1} {ρ}_{0 , 4 k}^{1} {\tilde{w}}_{0} ( iT - Δ ɛ T ) + {h}_{1} {ρ}_{1 , 4 k}^{1} {\tilde{w}}_{1} ( - Δɛ T ) + \tilde{n} ( 4 k T ) \\ {y}_{Δ τ} ( 4 k ) = {h}_{0} {\sum }_{i = - 1}^{1} {ρ}_{0 , 4 k - i}^{0} {\tilde{w}}_{0} ( i T + Δ ɛ T ) + {h}_{0} {ρ}_{1 , 4 k}^{0} {\tilde{w}}_{1} ( Δ ɛ T ) + {h}_{1} {\sum }_{i = - 1}^{1} {ρ}_{0 , 4 k - 1}^{1} {\tilde{w}}_{0} ( iT ) + {h}_{1} {ρ}_{1 , 4 k}^{1} {\tilde{w}}_{1} ( 0 ) + \tilde{n} ( 4 kT + Δ ɛ T )$$
where \tilde{w}₀ and \tilde{w}₁ are filtered versions of a main pulse w₀ and a secondary pulse w₁.

6. The method as claimed in claim 5, wherein the metrics of the Viterbi algorithm are defined by
$$λ ( {S}_{n - 1} ( i ) \to {S}_{n} ( j ) ) = {\sum }_{m = - 1}^{2} [ {\vert {B}_{m , n}^{( 0 )} \vert}^{2} + {\vert {B}_{m , n}^{( Δ τ )} \vert}^{2} ]$$
$$with$$
$${B}_{m , n}^{( 0 )} = y ( 4 n + m ) - {h}_{0} ( {\sum }_{i = - 1}^{1} {ρ}_{0 , 4 n + m - i}^{0} {\tilde{w}}_{0} ( i T ) + {ρ}_{1 , 4 n + m}^{0} {\tilde{w}}_{1} ( 0 ) ) - {h}_{1} ( {\sum }_{i = - 1}^{1} {ρ}_{0 , 4 n + m - i}^{1} {\tilde{w}}_{0} ( iT - Δ ɛ T ) + {ρ}_{1 , 4 n + m}^{1} {\tilde{w}}_{1} ( - Δ ɛ T ) )$$
$${B}_{m , n}^{( Δ τ )} = {y}_{Δ τ} ( 4 n + m ) - {h}_{0} ( {\sum }_{i = - 1}^{1} {ρ}_{0 , 4 n + m - i}^{0} {\tilde{w}}_{0} ( i T + Δ ɛ T ) + {ρ}_{1 , 4 n + m}^{0} {\tilde{w}}_{1} ( Δ ɛ T ) ) - {h}_{1} ( {\sum }_{i = - 1}^{1} {ρ}_{0 , 4 n + m - i}^{1} {\tilde{w}}_{0} ( i T ) + {ρ}_{1 , 4 n + m}^{1} {\tilde{w}}_{1} ( 0 ) )$$
where \tilde{w}₀ and \tilde{w}₁ are filtered versions of a main pulse w₀ and a secondary pulse w₁.

7. The method as claimed in claim 1, wherein in the presence of multiple paths, the method comprises a step (E54′) of estimating the propagation channel in such a way as to obtain the estimates of \tilde{f}ₘ⁰, \tilde{f}ₘ^{0,Δτ}, \tilde{f}ₘ¹, \tilde{f}ₘ^{1,Δτ}, the Viterbi algorithm using the estimated parameters of the channel, the metrics of the Viterbi algorithm being defined by
$$λ ( {S}_{n - 1} ( i ) \to {S}_{n} ( j ) ) = {\sum }_{m = - 1}^{2} [ {\vert {B}_{m , n}^{( 0 )} \vert}^{2} + {\vert {B}_{m , n}^{( Δ τ )} \vert}^{2} ]$$
$$with$$
$${B}_{m , n}^{( 0 )} = y ( 4 n + m ) - ( {\sum }_{i = - \frac{( {N}_{t} - 1 )}{2}}^{i = \frac{( {N}_{t} - 1 )}{2}} {ρ}_{0 , 4 n + m - i}^{0} {\tilde{f}}_{0 , {n}_{p}}^{0} ( i ) + {\sum }_{i = - \frac{( {N}_{t} - 3 )}{2}}^{i = \frac{( {N}_{t} - 3 )}{2}} {ρ}_{1 , 4 n + m - i}^{0} {\tilde{f}}_{1 , {n}_{p}}^{0} ( i ) + {\sum }_{i = - \frac{( {N}_{t} - 1 )}{2}}^{i = \frac{( {N}_{t} - 1 )}{2}} {ρ}_{0 , 4 n + m - i}^{1} {\tilde{f}}_{0 , {n}_{p}}^{1 , Δ τ} ( i ) + {\sum }_{i = - \frac{( {N}_{t} - 3 )}{2}}^{i = \frac{( {N}_{t} - 3 )}{2}} {ρ}_{1 , 4 n + m - i}^{1} {\tilde{f}}_{1 , {n}_{p}}^{1 , Δ τ} ( i ) )$$
$${B}_{m , n}^{( Δ τ )} = {y}_{Δ τ} ( 4 n + m ) - ( {\sum }_{i = - \frac{( {N}_{t} - 1 )}{2}}^{i = \frac{( {N}_{t} - 1 )}{2}} {ρ}_{0 , 4 n + m - i}^{0} {\tilde{f}}_{0 , {n}_{p}}^{0 , Δ τ} ( i ) + {\sum }_{i = - \frac{( {N}_{t} - 3 )}{2}}^{i = \frac{( {N}_{t} - 3 )}{2}} {ρ}_{1 , 4 n + m - i}^{0} {\tilde{f}}_{1 , {n}_{p}}^{0 , Δ τ} ( i ) + {\sum }_{i = - \frac{( {N}_{t} - 1 )}{2}}^{i = \frac{( {N}_{t} - 1 )}{2}} {ρ}_{0 , 4 n + m - i}^{1} {\tilde{f}}_{0 , {n}_{p}}^{1} ( i ) + {\sum }_{i = - \frac{( {N}_{t} - 3 )}{2}}^{i = \frac{( {N}_{t} - 3 )}{2}} {ρ}_{1 , 4 n + m - i}^{1} {\tilde{f}}_{1 , {n}_{p}}^{1} ( i ) )$$

8. The method as claimed in claim 1, wherein in the presence of multiple paths, the method comprises a step of equalization, the Viterbi algorithm using the equalized signal, the metric for each node of the Viterbi being defined by
$$λ ( n ) = \{ \begin{matrix}{β}_{n} ( 2 {x}_{n} - ( D - C ) ζ {β}_{n + 3} - C ζ {β}_{n + 1} - D ζ {β}_{n - 3} ) - A χ {\vert {β}_{n} \vert}^{2} & if n = 4 k \\ {β}_{n} ( 2 {x}_{n} - ( D - C ) ζ {β}_{n + 1} - C {ζβ}_{n - 1} - D {ζβ}_{n + 3} ) - A χ {\vert {β}_{n} \vert}^{2} & if n = 4 k + 1 \\ {β}_{n} ( 2 {x}_{n} - ( D - C ) ζ {β}_{n - 1} - D {ζβ}_{n + 1} - D {ζβ}_{n - 3} ) - A χ {\vert {β}_{n} \vert}^{2} & if n = 4 k + 2 \\ {β}_{n} ( 2 {x}_{n} - D {ζβ}_{n - 1} - C {ζβ}_{n + 3} ) - A χ {\vert {β}_{n} \vert}^{2} & if n = 4 k + 3\end{matrix} \\ with \\ χ = {\vert {h}_{0} \vert}^{2} + {\vert {h}_{1} \vert}^{2} \\ ζ = Im ( {h}_{0}^{*} {h}_{1} ) \\ A = \frac{1}{2} ( {\tilde{w}}_{0} ( 0 ) + {\tilde{w}}_{0} ( Δ ɛ T ) ) \\ C = \frac{1}{2} ( {\tilde{w}}_{0} ( - T ) + {\tilde{w}}_{0} ( - T + Δ ɛ T ) ) \\ D = \frac{1}{2} ( {\tilde{w}}_{0} ( T ) + {\tilde{w}}_{0} ( T + Δ ɛ T ) )$$
where \tilde{w}₀ and \tilde{w}₁ are filtered versions of a main pulse w₀ and a secondary pulse w₁.

9. The method as claimed in claim 1, wherein the pseudo-symbols ρ_{0,i}⁰, ρ_{1,i}⁰ corresponding to the information bits transmitted over the antennas A1, A2, are expressed
$${ρ}_{0 , i}^{p} = \{ \begin{matrix}( 2 {b}_{i}^{( p )} - 1 ) & if i is even \\ j ( 2 {b}_{i}^{( p )} - 1 ) & if i is odd\end{matrix} \\ {ρ}_{1 , i}^{p} = \{ \begin{matrix}- j ( 2 {b}_{i - 2}^{( p )} - 1 ) ( 2 {b}_{i - 1}^{( p )} - 1 ) ( 2 {b}_{i}^{( p )} - 1 ) & if i is even \\ - ( 2 {b}_{i - 2}^{( p )} - 1 ) ( 2 {b}_{i - 1}^{( p )} - 1 ) ( 2 {b}_{i}^{( p )} - 1 ) & if i is odd\end{matrix}$$

10. The method as claimed in claim 1, comprising a step of decoding the LLRs by means of a channel decoder or obtaining the heavy-weight bits of the LLRs.

11. A receiving device comprising a processing unit configured to implement a method as claimed in claim 1.

12. A computer program product comprising code instructions for executing a method as claimed in claim 1, when the latter is executed by a processor.
